(19) United States
(12) Patent Application Publication
(10) Pub. No.: US 2026/0037527 A1
(43) Pub. Date: Feb. 5, 2026

(54) Techniques for K-Nearest Neighbour Queries

(71) Applicant: Ordnance Survey Limited, Southampton (GB)

(72) Inventor: Sheng Zhou, Southampton (GB)

(21) Appl. No.: 19/284,850

(22) Filed: Jul. 30, 2025

(30) Foreign Application Priority Data
Jul. 30, 2024 (GB) 2411135.3

(51) Int. Cl. G06F 16/2458

(52) U.S. Cl. CPC G06F 16/2462

(57) ABSTRACT

Methods and systems for performing K-nearest neighbour (K-NN) queries on a spatial dataset in a distributed or parallel computing system are described herein, where the spatial data comprises query data and object data. The spatial dataset is pre-processed, whereby the query space (i.e., the spatial extent of the query data) is partitioned according to a particular partition scheme. For each partition, an area (defined as the object range of the partition) is calculated based on the geometry of the partition and a set of K candidate objects allocated to that partition, with all objects within the object range defining the extent of any subsequent K-NN queries performed on that partition. When the query dataset is subsequently partitioned using the same partition scheme to perform a K-NN query, the pre-processed object range information can be used to retrieve the objects to be queried for each partition.

### FIELD

Aspects described herein relate to a computer implemented method and system for performing K-nearest neighbour (K-NN) queries (also known as K-NN search) on metric datasets such as spatial and network data in a distributed or parallel computing environment. In particular, aspects described herein relate to a method of performing K-NN queries on a distributed or parallel computing system in which the dataset to be queried is pre-processed to obtain information that will facilitate subsequent repeated K-NN queries at scale efficiently.

### BACKGROUND

Metric datasets contain data upon which a distance metric may be defined. One of the most common examples of a metric dataset is a spatial dataset, which are used as a means for storing and querying data representative of objects defined in geographic space, and is used to store and analyse information about different geographic areas. Within the spatial dataset, objects of the geographic area may be represented as point features, linear features and areal features. For example, individual landmarks may be represented as point features, road networks, rail lines, coastlines and waterways may be represented as linear features, and building outlines and geographic regions such as towns, cities and counties or states may be represented as areal features.

A K-nearest neighbours (K-NN) query is one of the most frequently performed queries in a spatial dataset, as well as other types of metric datasets. For example, a single K-NN query may be to find the K=6 nearest primary schools to an address “X”, in which schools are the objects to be queried and each address is a query location. Generally speaking, in a centralised database system on a single computer, a single K-NN query may be easily solved and most spatial database servers are optimised to handle K-NN queries efficiently via the utilisation of appropriate spatial indices, for example, an R-Tree data structure.

However, if the size of the object set is very large, and/or if a very large number of queries are to be made, the K-NN queries need to be performed in a distributed or parallel computing environment with multiple computing nodes. The key to efficient parallel computation is to partition the data to be processed into multiple units in such a way that each unit may be processed by a single computing node independently whenever possible and the communication between nodes is minimised, or (for some environments) eliminated. In the case of K-NN queries, while it is simple to partition queries into multiple units each of which is processed on an individual computing node, the subset of the object set required to process a query unit is hard to determine because the K nearest neighbours of a query is unknown prior to processing and could include any members of the object set. Since it is inefficient or infeasible (e.g., in cases where the object set is very large) to pass on the entire object set to each computing node, a method of identifying a subset of the object set which is large enough to contain the K nearest neighbours for all queries in a query unit, but small enough to fit within the capacity of a single computing node, is required.

Current systems, in the case of spatial datasets, will first partition the queries spatially, then for each query partition, an object set is retrieved by a spatial extent, which is conventionally generated by buffering the query partition geometry over certain distance. If the retrieved object contains at least K objects, and for all queries in the partition, the distance from any query to its K-th nearest neighbour object in the retrieved object set is not greater than the distance from the query to the nearest point on the boundary of the above mentioned spatial extent for object retrieval, the query process for this partition is then completed. If this is not the case (i.e. the distance from a query to its K-th nearest neighbour object found from the retrieved object set is greater than the distance to the nearest point on the boundary), there may be objects closer to the query location but are outside of the current spatial extent, and are therefore not retrieved. Consequently, this spatial extent may have to be enlarged repeatedly to retrieve more and more objects, until the criteria for completion are met.

There are several issues with such an approach. Firstly, repeated expansion of the spatial extent and object re-retrieval is often an expensive operation in a distributed/parallel computing environment. Secondly, if an expansion takes place, some (if efforts are made to track queries that have satisfied the criteria) or all of the queries have to be re-run, which will increase the amount of computation required. Finally, this process is one-off and has to be repeated again if a different set of queries are performed on the object set.

Another approach followed by some current systems in order to handle a very large object set is to divide the object set into many partitions that are small enough to be processed on a computing node, then for a query location, the K-NN query is performed on each of the object partitions to return a set of up to K objects from each partition. All of the returned objects from processing the various partitions are then merged and filtered to acquire the K nearest objects to the query location as the final output.

This approach also has its severe limitations. This method effectively performs a query on the entire object dataset in order to find the K-NN objects which are usually in the proximity of the query location. As a result, most of the processing taking place on all of the partitions are redundant, but redundancy cannot be reduced due to the fact that it is unknown as to which parts of the processing redundant until all results are returned, merged and filtered. Such a large redundancy in the processing also has two undesirable implications that will significantly degrade the query performance in a distributed/parallel environment. Firstly, the volume of data communication between nodes will be huge; secondly, for a large number of queries to be processed, they can only be performed in small batches, which will introduce extra overheads. If a large query batch is sent out, the total size of results returned from all partitions could be so large that it would exceed the capacity of the computing node for handling the merge/filter tasks.

### SUMMARY

Aspects described herein address the above noted problems by providing a computer-implemented method and system for performing K-nearest neighbour (K-NN) queries on a metric dataset such as spatial dataset in a distributed or parallel computing system, wherein the dataset comprises query data (i.e., the query locations) and object data (i.e., the data to be queried). The spatial extents upon which the query data and object data are defined (typically defined as the regions bounding the query data and object data, and referred herein as the query space and object space respectively) may be identical or overlapping, or in some cases, they may be separated from each other completely. The spatial dataset is pre-processed, whereby the query space is partitioned according to a particular partition scheme. For each partition, an area within the union of the query space and object space (defined as the object range of the partition) is calculated based on the geometry of the partition and K candidate objects that are selected from the object set, such that the distance from any location in the partition to the furthest object in the K candidate objects is not greater than the distance from the same location to the nearest point on the boundary of the object range. As such, when the query dataset is subsequently partitioned using the same partition scheme (e.g., in order to perform a K-NN query), for each partition the pre-processed object range information can be used to retrieve a set of objects that contains at least the K candidate objects. In doing so, this guarantees the inclusion of the K-NN objects for any query location within the partition. That is to say, if there are additional objects within the object range of the partition, the K-NN of a query location in the partition will be determined from the K candidate object plus the additional objects within the partition, and if there are no additional objects within the object range, the K candidate objects will be the K-NN objects of the query location.

Large scale K-NN queries can then be performed by distributing the partitions between multiple processors of a distributed or parallel computing system, along with the objects retrieved using the pre-processed object range information. In doing so, the amount of data to be processed by each processor is significantly reduced, since it is not necessary to query the entire object dataset for each query location. Instead, for any query locations within a partition, only the objects defined by the object range of that partition need to be queried, thus enabling large scale K-NN queries to performed efficiently and without requiring significant processing power or extensive data communication among processing means to acquire the additional objects, whilst still guaranteeing an accurate set of results for each query.

A first aspect of the present disclosure provides a computer-implemented method of performing K-nearest neighbour (K-NN) queries on a spatial dataset in a distributed or parallel computing system, the distributed or parallel computing system comprising a plurality of processing means, and the spatial dataset comprising a query dataset and an object dataset, wherein the method comprises receiving instructions to perform a K-NN query on the spatial dataset to find a set of k-NN objects for a plurality of query locations of the query dataset, wherein k is an integer value greater than or equal to one, generating a plurality of partitions of the query dataset according to a first partition scheme, determining, for each partition, a set of objects to be queried from the object dataset based on pre-processed object range information associated with the partition and K candidate objects allocated to each partition, wherein K is an integer value greater than or equal to the integer value of k, wherein the pre-processed object range information is determined using the first partition scheme, distributing the plurality of partitions and the respective sets of objects to be queried between the plurality of processing means to perform the K-NN query, wherein each processing means processes one or more partitions to determine a set of k-NN objects associated with each query location of a partition, receiving one or more sets of k-NN objects from each processing means, and collating the one or more sets of k-NN objects from each processing means for output.

As such, the spatial extent of the query data (i.e., the region bounding the query data) is partitioned according to particular scheme, and then pre-processed object range information is used to identify the objects to be queried as part of each partition. Here, the object range information defines the extent of the object dataset that needs to be retrieved for performing queries on each partition. One or more partitions can then be sent to each of the processors of a distributed or parallel computing system to perform the K-NN query for each query location within a partition on the relevant set of objects. The results are then returned and collated for output. In this regard, the method may further comprise outputting the K-NN results, for example, to a display, in any suitable format. For example, in the case of geospatial data, the K-NN results may be output in a visual representation of a map. By using the pre-processed object range information to identify the objects to be queried for each partitions, the amount of data to be processed by each processor is significantly reduced, thus enabling large scale K-NN queries to performed efficiently and without requiring significant processing power, whilst still guaranteeing an accurate set of results for each query. It will also be appreciated that the K candidate objects is a predetermined number of candidate objects, where 1≤k≤K.

In some arrangements, the plurality of partitions are generated such that each partition comprises at least one query location. In this respect, it will be appreciated that each partition may comprise multiple query locations. Similarly, it will be understood that a query location may fall within multiple partitions, for example, where a query location falls along a boundary of two partitions.

In some cases, generating the plurality of partitions may comprise receiving pre-processed partition data for the query dataset, wherein the pre-processed partition data comprises the plurality of partitions. The pre-processed object range information may comprise the set of objects to be queried for each partition. That is to say, the objects to be queried may be pre-processed and stored for use in performing subsequent K-NN queries.

Alternatively, the pre-processed object range information may comprise an object range for each partition, the object range comprising one or more areas of the spatial dataset, each area being enclosed by a circle having a radius calculated based on a maximum distance between a vertex of the boundary of the partition and K candidate objects allocated to the partition. As such, the object range defines the portion of the spatial dataset from which objects are to be retrieved for use in performing K-NN queries on the given partition. In this respect, the object range of a partition may be defined as the union of each area calculated for each vertex of the partition boundaries.

In such cases, the method may further comprise pre-processing the spatial dataset to determine the object range of each partition, wherein the pre-processing comprises identifying each vertex of the boundaries of the partition, allocating K candidate objects to the partition, calculating, for each vertex of the partition boundary, an area being enclosed by a circle having a radius calculated based on the maximum distance between the vertex and the K candidate objects, and determining the object range of the partition based on a union of the area calculated for each vertex of the partition boundary.

As described above, it will be appreciated that the K candidate objects is a predetermined number of candidate objects, where K may be an integer value more than or equal to one. The candidate objects used to calculate the object range may therefore be any K candidate objects from the object set, however, it will be most efficient to select candidate objects so that the size of resulting object range is minimised. Additionally, an object range calculated for a given K value will support k-NN queries in the partition for any 1≤k≤K. In case of k=K, the object range reaches its maximum efficiency; in cases of k<K, the object range calculated at K will contain some objects redundant to the smaller k, and is less efficient compared to an object range calculated for the smaller k. Alternatively, multiple object ranges for different numbers of candidate objects may be computed individually to support multiple K-NN queries of different size K.

As such, it will be appreciated that the size of the partitions and/or the number and distribution of the candidate objects may be selected so as to provide an object range (and thus set of objects to be queried) that is small enough to be efficiently processed by each of the processing means.

It will also be understood that the distance metric used to calculate the object range may depend on the nature of the data to be queried.

In some arrangements, determining the set of objects to be queried for each partition may comprises identifying the objects within the area calculated for each vertex of the partition boundary. More specifically, the objects within the union of the areas calculated for each vertex may be identified.

Collating the one or more sets of k-NN objects may comprise identifying a query location processed within two or more partitions, such that two or more sets of k-NN objects are received, removing any duplicate k-NN objects contained within the two or more sets of K-NN objects, and ranking the remaining k-NN objects in dependence on a distance from the query location and each K-NN object to thereby provide a final set of k-NN objects for the query location.

As such, where a query location is covered by two or more partitions (e.g., it lies on a boundary), the query location will be processed as part of each respective partition, each partition having its own object range and respective set of objects to be queried. As such, two or more sets of results will be returned for the query location, and any conflicts between those results must therefore be resolved. This can thus be done by removing any duplicate results, and then comparing the remaining results based on their distance to the query location to find the final k-NN objects. If more than k results are found, those that are the furthest will be disregarded until k objects are left.

The first partition scheme may comprise one of: a grid system, a quadtree or a Voronoi diagram. It will of course be appreciated that any suitable scheme for partitioning the query dataset may be used depending on the size, distribution and/or nature of the data.

In some examples, the spatial dataset may comprise geospatial data representative of a geographical region.

In some arrangements, the query dataset and object dataset may comprise one or more of: data points, line segments and polygons.

In some arrangements, the plurality of processing means may also be used to generate the plurality of partitions and/or determine the set of objects to be queried on each partition.

A further aspect described herein provides a system comprising a processor, and a computer readable medium storing one or more instruction(s) arranged such that when executed the processor is caused to perform the method of performing K-NN queries as described above.

The system may further comprise a distributed computer system comprising a plurality of computing nodes, wherein the plurality of partitions are distributed between the plurality of computing nodes.

Alternatively, the system may further comprise a parallel computing system comprising a plurality of processors, wherein the plurality of partitions are distributed between the plurality of processors.

Another aspect described herein provides a computer-implemented method of pre-processing a spatial dataset for use in K-nearest neighbour (K-NN) queries to be performed in a distributed or parallel computing system, the spatial dataset comprising a query dataset and an object dataset, wherein the method comprises generating a plurality of partitions of the query dataset according to a first partition scheme, allocating, to each partition, K candidate objects from the object dataset, wherein K is an integer value greater than or equal to one, determining an object range for each partition, the object range of each partition comprising one or more areas of the spatial dataset, each area being enclosed by a circle having a radius calculated based on a maximum distance between a vertex of a boundary of the partition and the K candidate objects, and storing object range information for use in K-NN queries of the spatial dataset, the object range information at least comprising the object range determined for each partition.

As such, the spatial data is pre-processed by partitioning the query space according to particular scheme, and then calculating the object range for each partition using K candidate objects (where K≥1) allocated to each partition. Here, the object range defines the portion of the spatial dataset from which objects are to be retrieved for use in performing K-NN queries on the given partition. This object range geometry may then be stored and used on the fly to retrieve objects for queries on the corresponding partition. By pre-processing and storing this information, large scale K-NN queries can be performed efficiently and without requiring significant processing power or extensive data communication among processing means, whilst still guaranteeing an accurate set of results for each query.

Furthermore, an object range calculated for a given K value will support k-NN queries in each partition for any 1≤k≤K. As such, by pre-processing the data in this way, this guarantees the inclusion of the K-NN objects for any query location within the partition. That is to say, if there are additional objects within the object range of the partition, the K-NN of a query location in the partition will be determined from the K candidate object plus any additional objects within the partition, and if there are no additional objects within the object range, the K candidate objects will be the K-NN objects of the query location.

In some arrangements, determining the object range for each partition may further comprise identifying each vertex of the boundaries of the partition, calculating, for each vertex of the partition boundary, an area being enclosed by a circle having a radius calculated based on the maximum distance between the vertex and the K candidate objects, and determining the object range of the partition based on a union of the area calculated for each vertex of the partition boundary.

The candidate objects used to calculate the object range may be any K candidate objects, however, it will be appreciated that the size of the partitions and/or the number and distribution of the candidate objects may be selected so as to provide an object range (and thus set of objects to be queried) that is small enough to be efficiently processed during a K-NN query.

It will of course be understood that the distance metric used to calculate the object range may depend on the nature of the data to be queried.

In some arrangements, allocating K candidate objects may comprise allocating a predetermined number of candidate objects to each partition based on containment within the partition and/or adjacency to the partition. That is to say, a given number of candidate objects may be allocated to each partition, with candidate objects being allocated based on whether they are contained within the partition or in close proximity. For example, if the K=3 objects are to be allocated to each partition, and a partition only has two objects contained therein, the closest object in an adjacent partition may also be allocated to that partition.

In some arrangements, storing object range information may further comprise storing the plurality of partitions as partition data.

In other arrangements, storing object range information may further comprise storing object data for use in K-NN queries, the object data comprising one or more objects contained within the area of the spatial dataset defined by the object range of each partition. That is to say, the set of objects within each object range may also be stored for use in subsequent K-NN queries, rather than using the object range geometry to retrieve objects on the fly.

The method may further comprise determining a plurality of object ranges for each partition based on two or more sets of K candidate objects for each partition, each set of K candidate objects comprising a different number of objects. That is to say, different sets of candidate objects may be used to calculate multiple object ranges to support multiple K-NN queries of different size K. Although an object range calculated for K objects will also support a k-NN query for any 1≤k≤K, it is most efficient when k=K, and thus it may be beneficial to calculate a dedicated object range for different K values, to support a range of k-NN queries.

The first partition scheme may comprise one of: a grid system, a quadtree or a Voronoi diagram. It will of course be appreciated that any suitable scheme for partitioning the query dataset may be used depending on the size, distribution and/or nature of the data.

In some examples, the spatial dataset may comprise geospatial data representative of a geographical region.

The object dataset may comprise one or more of: data points, line segments and polygons.

A further aspect described herein provides a system comprising a processor, and a computer readable medium storing one or more instruction(s) arranged such that when executed the processor is caused to perform the method of pre-processing the spatial dataset for use in K-NN queries described above.

It will of course be appreciated that the method of pre-processing the spatial dataset may be performed by a distributed or parallel computing system comprising a plurality of processing means. For example, once partitions have been generated, each partition may be distributed to a processing means to determine the object range of each partition.

### BRIEF DESCRIPTION OF THE DRAWINGS

Further features and advantages described herein will become apparent from the following description of aspects thereof, presented by way of example only, and by reference to the drawings, wherein:

FIG. 1 is a flow diagram illustrating a method of pre-processing a dataset for use in K-NN queries according to one or more illustrative aspects described herein;

FIG. 2 is a flow diagram illustrating a method of performing K-NN queries on a dataset according to one or more illustrative aspects described herein;

FIGS. 3A-3D illustrate metrics used in one or more illustrative aspects described herein;

FIGS. 4A-4D further illustrate metrics used in one or more illustrative aspects described herein;

FIGS. 5A-5B further illustrate metrics used in one or more illustrative aspects described herein;

FIG. 6 is a diagram illustrating object ranges used in one or more illustrative aspects described herein;

FIGS. 7A-B are diagrams further illustrating object ranges used in one or more illustrative aspects described herein;

FIG. 8 is a further diagram illustrating object ranges used in one or more illustrative aspects described herein;

FIGS. 9A-9B are further diagrams illustrating object ranges used in one or more illustrative aspects described herein;

FIGS. 10A-10B are further diagrams illustrating object ranges used in one or more illustrative aspects described herein;

FIG. 11 is another diagram illustrating object ranges used in one or more illustrative aspects described herein;

FIG. 12 is a diagram further illustrating object ranges used in one or more illustrative aspects described herein;

FIGS. 13A-13B are further diagrams illustrating object ranges used in one or more illustrative aspects described herein;

FIG. 14 is yet a further diagram illustrating object ranges used in one or more illustrative aspects described herein;

FIG. 15 is a further diagram illustrating object ranges used in one or more illustrative aspects described herein;

FIGS. 16A-16D are diagrams further illustration a partition scheme that may be implemented in one or more illustrative aspects described herein;

FIGS. 17A-17B are diagrams further illustration a partition scheme that may be implemented in one or more illustrative aspects described herein;

FIG. 18 is a diagram illustrating an object range of a partition that may be implemented in one or more illustrative aspects described herein;

FIG. 19 illustrates one example of a system on which one or more illustrative aspects described herein may be implemented;

FIGS. 20A-D are diagrams illustrating the process of partitioning a network in one or more illustrative aspects described herein;

FIG. 21 is a further diagram illustrating object ranges used in one or more illustrative aspects described herein;

FIG. 22 is a diagram illustrating the partitioning of a spatial network in one or more illustrative aspects described herein;

FIG. 23 is a diagram further illustrating one or more illustrative aspects described herein.

### DETAILED DESCRIPTION

As described previously, K-nearest neighbour (K-NN) queries are a common type of query on metric data such as spatial datasets, but are particularly inefficient in particular cases, specifically, cases in which the size of the object set is beyond the capacity of a single computer and/or the number of queries is large so that the queries have to be performed in a distributed or parallel computing environment.

One of the characteristics of K-NN queries is that the range of the neighbourhood search to be performed is unknown prior to the search, and depends on the location of the query and the distribution of objects in the object dataset. On the one hand, the search process must find at least K objects, but on the other hand, the search process also needs to ensure no other objects can be closer to the query location than the found K objects. This is complicated further in cases where the query location may be represented by multiple points (e.g. in case of spatial data, such as a line string or a polygon). In aspects described herein, a dataset is pre-processed, and the results of said processing are stored for use in performing largescale K-NN queries in a distributed or parallel computing environment.

### OVERVIEW

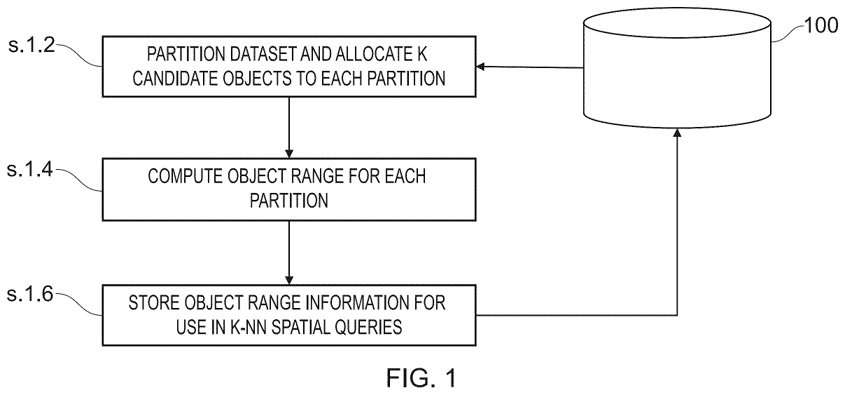

FIG. 1 illustrates a method of pre-processing a dataset for use in performing repeated and largescale K-NN queries in a distributed or parallel computing environment in accordance with aspects described herein. Here, the query space (i.e., the extent of the query dataset) is first partitioned, with K candidate objects being allocated to each partition. For each partition, an “object range” is calculated based on the extent of the partition and the K candidate objects allocated to the partition. Further details of the “object range” will be described below. Finally, the object range and any associated information is stored for use in subsequent K-NN queries.

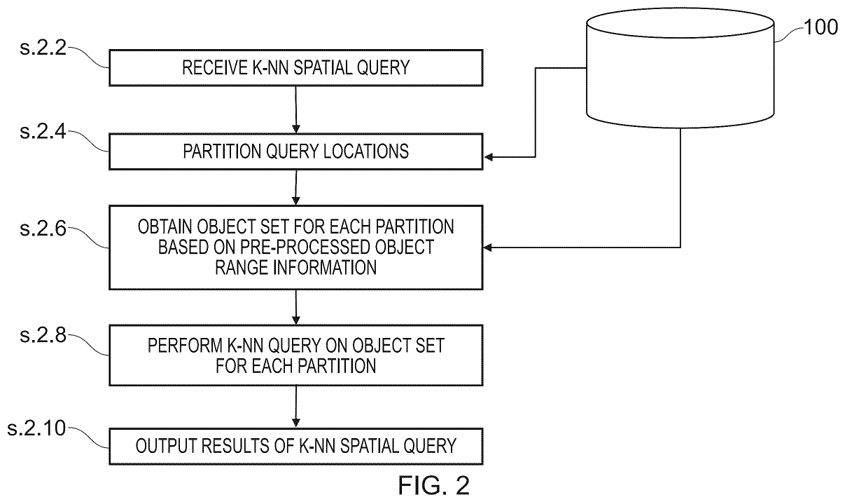

FIG. 2 illustrates a method of performing K-NN spatial queries on an object dataset according to aspects described herein, in which the pre-processed data is used. Here, once a set of K-NN queries is received, the queries are partitioned using the same partition framework as that used for partitioning the query space during the pre-processing. The pre-processed object range information is then used to determine an object set for each partition, with the K-NN query then being performed on the determined object set. The results of the K-NN query are then collated and output for use, for example, by generating a suitable visual representation of the K-NN data.

The details of the pre-processing and the method of performing K-NN queries will now be described.

### Definitions

To aid understanding of the following discussion, we hereby provide the following definitions that will be used throughout the following description.

Given a metric space (X, d) where X is a non-empty set of data points and d: X×X→R is a metric (also referred to as distance function) defined on X, we first define:
d(q, o) (q, o∈X): the original metric of distance between two data points (q, o) in X.
Object O={oᵢ|i=1, 2, . . . }⊂X: an object O is a subset on X, where oᵢ denotes a data point on X. The number of data points in the subset may be finite or infinite. A single-point object is a set that contains only one element. A multi-point object may be a finite collection of discrete data points, or a set of infinite data points (e.g., lines or polygons in case of spatial dataset).
Query Q={qᵢ| i=1, 2, . . . }⊂X: a query is a subset on X, where qᵢ denotes a point on X. The number of data points in the subset may be finite or infinite. A single-point query is a set that contains only one element. A multi-point query may be a finite collection of discrete data points, or a collection of infinite data points (e.g., lines or polygons).
Object Set O_{S}={Oᵢ|i=1,n}: a set of objects to be queried against. In this respect, it will be understood that each object in the object set is itself a set of data points.
Query Set Q^{S}={Qᵢ|i=1,m}: a set of queries. In this respect, it will be understood that each query in the query set is itself a set of data points.

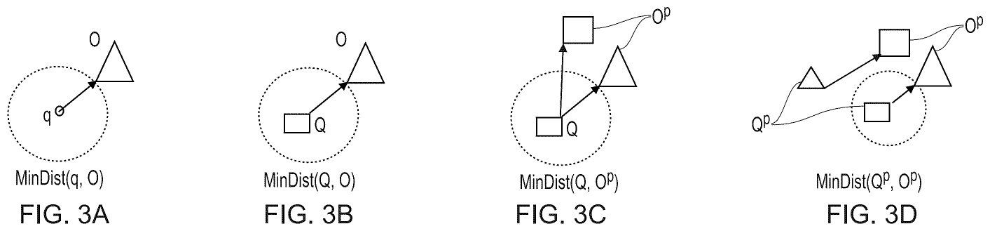

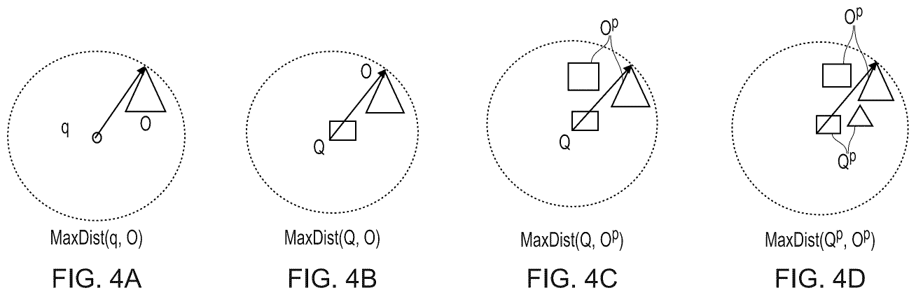

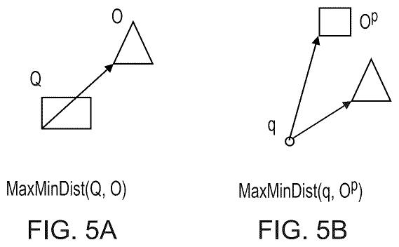

Subsequently, we define the following extended metrics:
MinDist(q, O) (q∈X, O⊂X)=inf{d(q,o):o⊂O}: minimum distance between a data point, q, and a set (i.e., an object), which is the distance between the data point and the nearest point in the set, as illustrated in FIG. 3A. This notation may be extended to MinDist(q, O^{P}) where O^{P} is a set of sets (i.e., an object set).
MinDist(Q, O) (Q, O⊂X)=inf{d(q,o):q∈Q,o∈O}=inf{MinDist(q,O):q⊂Q}: minimum distance between a query and an object (i.e. two sets of data points), which is the smallest distance between a point in Q to a point in O, as illustrated by FIG. 3B.
MinDist(Q, O^{P})=inf{MinDist(Q,O):O∈O_{P}}: minimum distance between a query and an object set, as illustrated by FIG. 3C.
MinDist(Q^{P}, O^{P})=inf{MinDist(Q,O^{P}):Q⊂Q^{P}}: minimum distance between a query set and an object set, as illustrated by FIG. 3D.
MaxDist(q, O) (q∈X, O⊂X)=sup{d(q,o):o∈O}: maximum distance between a data point and a set, which is the distance between the data point and the furthermost point in the set relative to the data point, as illustrated in FIG. 4A. This notation may be extended to MaxDist(q, O^{P}) where Q^{P} is a set of sets.
MaxDist(Q, O)=sup {d(q,o):q∈Q,o∈O}=sup{MaxDist(q,O):q∈Q}: maximum distance between a query and an object, that being the largest distance from a point in Q to a point in O, as illustrated in FIG. 4B.
MaxDist(Q, O^{P})=sup{MaxDist(Q,O):O∈O^{P}}: maximum distance between a query and an object set, as illustrated by FIG. 4C.
MaxDist(Q^{P}, O^{P})=sup{MaxDist(Q,O^{P}):Q∈Q^{P}}: maximum distance between a query set and an object set, as illustrated by FIG. 4D.
MaxMinDist(Q, O^{P})=sup{MinDist(q,O):q∈Q}: the maximum value of the minimum distance from any point in a query Q to the nearest point in an object O (a.k.a. semi-Harsdorff distance, which is directional), as illustrated by FIG. 5A.
MaxMinDist(q, O^{P})=sup {MinDist(q,O):O∈O^{P}}: maximum of the minimum distance from a point q to an object set O^{P}, as illustrated by FIG. 5B.

It is also worth noting that, in the above definitions. “inf” and “sup” denote the greatest lower bound and the least upper bound respectively. Additionally, for two single-point sets {q} and {o}, all of the above extended metric definitions are simplified to the original metric d(q, o), that is, the distance between two data points.

Based on the above notations, the K-NN query may be formally defined as: given a metric space (X, d), an object set O^{S} and a query set Q^{S} defined on (X, d), for each query Q in Q^{S}, find the K nearest objects in O^{S}, where MinDist(Q, O) is normally used to rank the closeness of objects to a query, although other extended distance metrics may also be used for the query.

### Object Space and Query Space

Theoretically speaking, objects and queries may appear at any location of the metric space in which they are defined. For any practical problem, they will present in subset regions of the metric space, i.e., the spatial extent on which the object and query data is defined. The subset regions of the metric space where objects and queries may be defined are regarded as an object space and a query space. These two spaces are not necessarily identical. Indeed, they may overlap partially or not intersect each other at all.

### Object Ranges

As will be described in more detail below, aspects described herein apply a concept referred to herein as an “object range”, and the following discussion provides the background to the principles on which aspects described herein are based. Generally speaking, given an object set and a given K, for a query set which may be a finite collection of concrete queries or a subset region of the query space upon which infinite number of queries may be defined, an object range for the query set is a subset region of the metric space that intersects the K nearest neighbours for all queries in the query set. By definition, the query set and the objects retrieved by the corresponding object range may be processed independent of other objects in the object set. Consequently, if the query space is divided into multiple partitions which covers the entire query space, an object range may then be defined for each partition. Subsequently, each pair of query-space partition and object range may be processed independently.

It will be appreciated that the object range for a query set may not be unique. Based on the metrics used, there is a minimum object range for a partition and any area in the query space that contains this minimum object range is also an object range for the partition. Indeed, the object space as the subset region covering the entire object set is an object range for any query sets. A smaller object range will normally result in a smaller number of objects to be queried and better performance.

The following discussion provides further details as to how the object range is determined and scaled up for use in performing large scale K-NN queries in a distributed or parallel computing environment.

### Object Range for a Single-Point K-NN Query

Given integer 1≤K≤n, a single point query Q={q}, and a set of objects O^{K}={Oᵢ|i=1, K}⊆O^{S} as a candidate object set, it is possible to define a set OR(Q, O^{K}) on X as the object range for the query Q{q} at k≤K with regard to O^{K}:

$$OR ( Q , {O}^{K} ) = O R ( q , {O}^{K} ) = \{ p \vert Dist ( p , q ) \leq MaxMin Dis t ( q , {O}^{K} ) \} \qquad [ 1 ]$$

Subsequently, taking K-NN (Q, O^{S}) to be the K nearest neighbours in O^{S} for Q, it can be said that:

$$KNN ( Q , {O}^{S} ) ⊆ O R ( Q , {O}^{K} ) . \qquad [ 2 ]$$

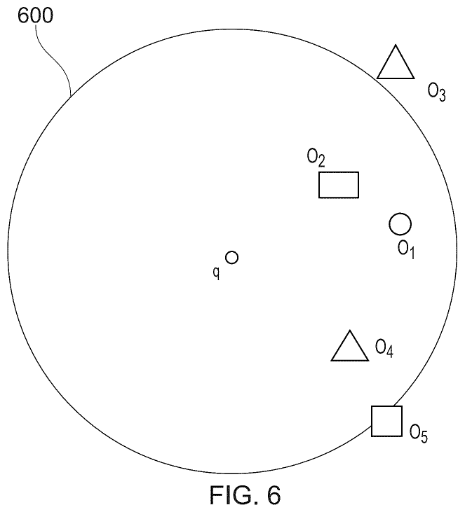

FIG. 6 shows an example of the object range (denoted by line 600) for a single point query, q, on a candidate object set O^{K}={o₁, o₂, o₃}, the candidate object set O^{K} being a subset of the object set O^{S} (i.e., the set of objects to be queried against). The method by which the candidate object set is selected will be described in more detail below. As illustrated by FIG. 6, the object range 600 has a circular shape centred at q with a radius MaxMinDist(q, O^{K}), that is the maximum value of the minimum distance from q to any of the data points within the object set O^{K}. In this example, the radius corresponds to the distance from query point, q, to the nearest data point on the object o₃.

By definition, at least one data point of all objects in the candidate object set intersects with the object range 600. If there are other objects O^{T}={O|O∈(O^{S}−O^{K})} not in the candidate object set that intersect the object range (e.g., objects o₄ and o₅ of FIG. 6), the K−NN for the query Q will be drawn from O^{K}∪O^{T} (i.e., the query will be performed on objects in both sets), wherein O^{K} guarantees the existence of K nearest neighbours for the query Q={q} in the case that there are no other objects interesting the object range.

### Object Range for Multiple Single-Point Queries

Given multiple single-point queries Q^{P}={Qᵢ={qᵢ}: i=1, m} and a candidate object set O^{K}, the following can be defined:

$$KNN ( {Q}^{P} , {O}^{S} ) ⊆ O R ( {Q}^{P} , {O}^{K} ) = U ( O R ( Q , {O}^{K} ) : Q ∈ {Q}^{P} ) . \qquad [ 3 ]$$

That is, the K nearest neighbours for these single-point queries are in the union of the object ranges of each query point relative to the same candidate object set O^{K}. In other words, object ranges are additive.

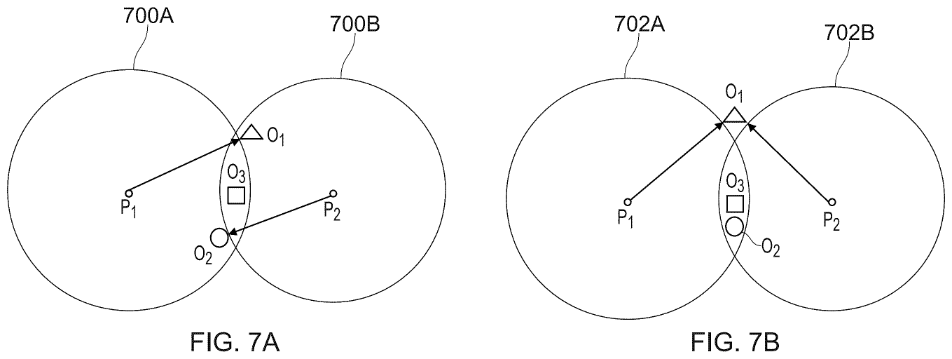

FIGS. 7A and 7B provide two different examples of the object range for multiple single point queries, Q^{P}={Q₁={p₁}, Q₂={p₂}} on the candidate object set O^{K}={o₁, o₂, o₃}. As before, O^{K} is a subset of the object set O^{S}. As shown in FIG. 7A, for each of the query points, the furthest object of the candidate object set may be different. In FIG. 7A, the furthest candidate object from query point p₁ is candidate object o₁, and thus the object range 700A of this query point is the disc centred at p₁ with the minimum distance from p₁ to o₁ as its radius. The furthest candidate object from query point p₂ is candidate object o₂, and thus the object range 700B of this query point is the disc centred at p₂ with the minimum distance from p₂ to o₂ as its radius. As such, the K-NN nearest neighbours for these two query points will be within the union of these two object ranges 700A, 700B.

As shown in FIG. 7B, for each of the query points, the furthest object of the candidate object set may be the same. In FIG. 7B, the furthest candidate object from query point p₁ is candidate object o₁, and thus the object range 702A of this query point is the disc centred at p₁ with the minimum distance from p₁ to o₁ as its radius. The furthest candidate object from query point p₂ is also candidate object o₁, and thus the object range 702B of this query point is the disc centred at p₂ with the minimum distance from p₂ to o₁ as its radius. However, in this case, the minimum distance from p₂ corresponds to a different point on o₁, compared to the minimum distance from p₁ that defines object range 702A. As before, the K-NN nearest neighbours for these two query points will thus be within these two object ranges 702A, 702B.

If two different candidate object sets O₁^{K} and O₂^{K}, are used for two queries Q₁, and Q₂, by definition, the object ranges are still additive:

$$KNN ( Q = \{ {Q}_{1} , {Q}_{2} \} , {O}^{S} ) ⊆ U ( O R ( {Q}_{1} , {O}_{1}^{K} ) , O R ( {Q}_{2} , {O}_{2}^{K} ) ) \qquad [ 4 ]$$

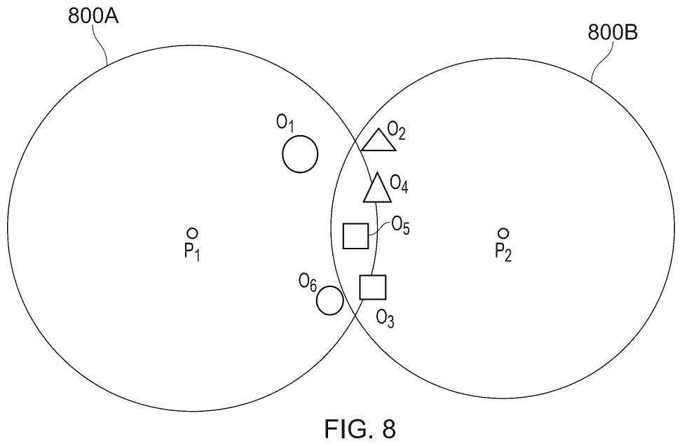

For example, FIG. 8 shows the object range of two point queries Q₁={p₁}, Q₂={p₂} on two different candidate object sets O₁^{K}={o₁, o₂, o₃} and O₂^{K}={o₄, o₅, o₆}. Here, the object range 800A of query point p₁ is the minimum distance to the furthest object in candidate object set O₁^{K}, which in this case is candidate object o₂. Similarly, the object range 800B of query point p₂ is the minimum distance to the furthest object in candidate object set O₂^{K}, which in this case is candidate object o₆.

As will be described further below, when calculating the object range for partitions of the space to be queried, it is important to select candidate objects that will result in an appropriately sized object range. If the object range is too big, this can result in an object set that is very large and require a significant amount of processing power to query. In such cases, it may be necessary to select a different candidate object set, to thereby provide a reduced object range that is more efficient to process.

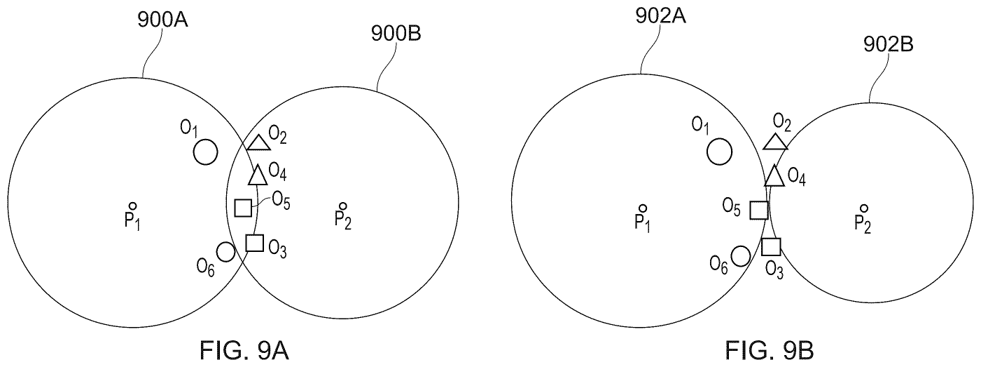

For example, as shown in FIG. 9A, if two object ranges 900A-B that have been calculated based on two different candidate object sets for K=3, O₁^{K}={o₁, o₂, o₃} and O₂^{K}={o₄, o₅, o₆}, a new set of candidate objects may be selected in order to reduce the object range. As shown in FIG. 9B, if a new candidate object set is selected as O^{K}={o₃, o₄, o₅}, the object range 902A of query point p₁ and 902B of query point p₂ is reduced, thus reducing the combined object range (union of 902A and 902B) of both point queries Q₁={p₁}, Q₂={p₂}.

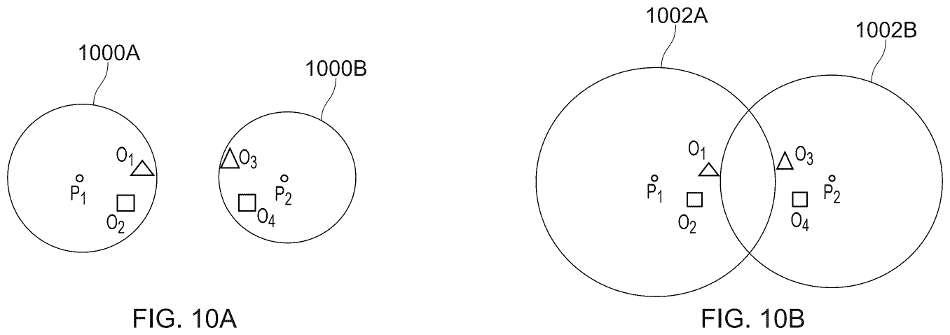

Conversely, as shown by FIGS. 10A-B, the reselection of the candidate object set may result in an enlarged object range. FIG. 10A shows the object ranges 1000A-B of two point queries Q₁={p₁}, Q₂={p₂} on two candidate object sets O₁^{K}={o₁, o₂} and O₂^{K}={o₃, o₄} for K=2. A new candidate object set may be selected as O^{K}={o₁, o₃}, thus resulting in larger object range as the union of 1002A-B for both point queries Q₁={p₁}, Q₂={p₂}.

### Object Range for a Multi-Point Query

A multi-point query is a single query with a set that contains multiple points. A group of scattered points is an example of a finite multi-point set, and lines and polygons defined on X are examples of infinite multi-point sets.

A multi-point query is effectively a collection of multiple single-point queries, as described above, with all points treated as belonging to just one query. In this respect, the K nearest neighbours for the individual points are accumulated and then re-ranked to return a single set of K nearest neighbours for the multi-point query.

As such, given a multi-point query Q={qᵢ| i=1, m}, the following can be defined:

$$KNN ( Q , {O}^{S} ) ⊆ O R ( Q , {O}^{K} ) = U ( O R ( {q}_{i} , {O}^{K} ) : {q}_{i} ∈ Q ) ; and \qquad [ 5 ]$$

$$KNN ( Q , {O}^{S} ) ⊆ U ( KNN ( {q}_{i} , {O}^{S} ) )$$

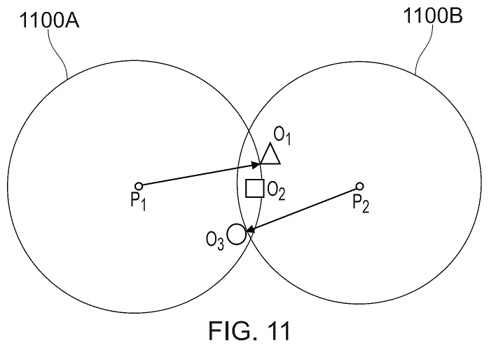

In other words, KNN (Q, O^{S}) may be derived from the collection of the K nearest neighbours of all points in Q. FIG. 11 shows an example of the object range (1100A-B) of a multi-point query with two points Q={p₁, p₂} on the candidate object set O^{K}={o₁, o₂, o₃}. In this respect, the arrows extending from the query points, p₁, p₂, indicate which candidate object is used to provide the maximum distance measurement.

### Extended Object Range on Multi-Point Objects

If the candidate object set O^{K} is a set of single-point objects, the following can be said for a set of query points Q={qᵢ|i=1, m) (either as standalone points, or as a multi-point query):

$$∀ O ∈ {O}^{K} , O ⊆ ∩ ( O R ( {q}_{i} , {O}^{K} ) \vert i = 1 , m ) \qquad [ 6 ]$$

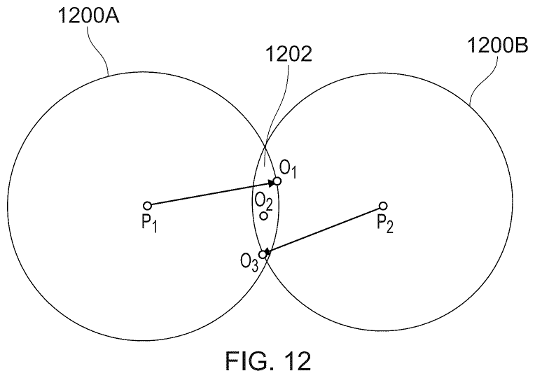

That is, given a candidate object set of single-point objects, these candidate objects are all contained by the intersection of the object ranges of the query points, as shown in FIG. 12, where all of the single point objects {o₁, o₂, o₃} are contained within the intersection 1202 of the object ranges 1200A and 1200B.

However, this does not apply to multi-point objects. As discussed above, for different query points the furthest point on a multi-point object may be different (as shown in FIG. 7B). To ensure the coverage of the whole multi-point object, the MaxDist is used instead of MaxMinDist to extend the initial definition of object range.

Given integer 1≤K≤n, a single point query Q={q}, and a set of objects O^{K}={Oᵢ| i=1, K}⊆O^{S} as the candidate object set, OR_{E}(Q, O^{K}) is defined as the Extended Object Range for Q{q} at k≤K with regard to O_{K}:

$$O {R}^{E} ( Q , {O}^{K} ) = O {R}^{E} ( q , {O}^{K} ) = \{ p \vert Dist ( p , q ) \leq MaxDist ( q , {O}^{K} ) \} . \qquad [ 7 ]$$

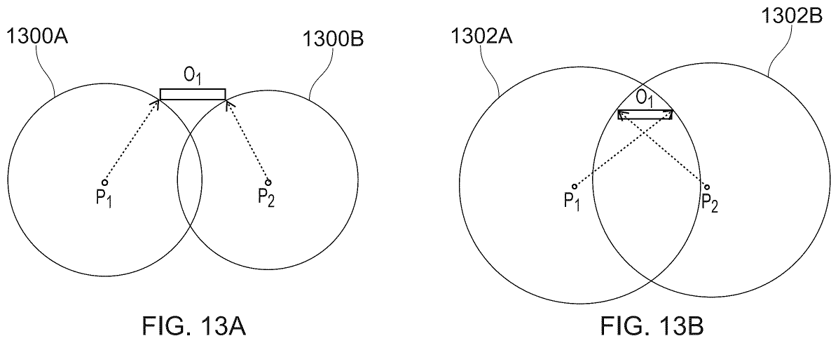

FIGS. 13A and 13B illustrate the difference between the object range for a multi-point object described previously, and an extended object range as defined by [7] above. In FIG. 13A, the object range for two query points is defined as the MaxMinDist to the multi-point object o₁. That is to say, the object ranges 1300A and 1300B of each query point p₁ and p₂ respectively is defined as the distance to the closest point of the object o₁. This is in contrast to FIG. 13B, where the extended object ranges 1302A and 1302B of each query point p₁ and p₂ respectively are defined as the MaxDist to the multi-point object o₁, that is, the distance from each query point to the furthest point of the object o₁.

The following can thus be stated:

$$KNN ( Q , {O}^{S} ) ⊆ O {R}^{E} ( Q , {O}^{K} ) = O {R}^{E} ( q , {O}^{K} ) \qquad [ 8 ]$$

It is therefore evident that OR(Q, O^{K})⊆OR^{E}(Q, O^{K}). A by-product of this extended object range is that the extended distance metrics, MaxDist and MaxMinDist, defined previously, may also be used as a metric to perform a KNN query, in addition to the conventional MinDist metric in K-NN queries.

For a multi-point query, the following can also be stated:

$$KNN ( Q , {O}^{S} ) ⊆ O {R}^{E} ( Q , {O}^{K} ) = U ( O {R}^{E} ( {q}_{i} , {O}^{K} ) : {q}_{i} ∈ Q ) \qquad [ 9 ]$$

As such, statement [6] can also be extended to cover multi-point objects:

$${O}^{K} ⊆ ∩ ( {OR}_{i}^{E} , \vert i = 1 , m ) \qquad [ 10 ]$$

### Object Range for Scalable KNN

For any subset QᵢS⊆Q as a new query, it is clear that the K nearest neighbours for Q₁ would be in the object range of Q. That is to say, the object range for a subset region of X can be computed and the K nearest neighbours for all queries that fall in this region will be in the computed object range. This therefore leads to a solution to the scalable KNN problem.

As stated previously, the query space is a subset of the metric space in question. All queries are defined in the query space. Given C={cᵢ|i=1, n}, C being a cover or partition of the query space on which the set of queries, Q^{S} are defined, a candidate set of objects, Oᵢ^{K}, which contain K objects from the object set, O^{S}, can be assigned to each subset ci, and an object range for each ci can be computed as OR(cᵢ, Oᵢ^{K}). In this respect, a “cover” represents a collection of subsets of the query space whose union is all of the query space. In a cover, two subsets might overlap (i.e., they contain some of the same data points not on their boundaries). Alternatively, a partition forms a non-overlapping cover of the query space. The following discussion will refer to a “partition” as being a subset of the query space generated by performing a covering or partitioning process.

As such, the following can be stated:

$$KNN ( {c}_{i} , {O}^{S} ) ⊆ O R ( {c}_{i} , {O}_{i}^{K} ) \qquad [ 11 ]$$

That is, it is possible to pre-compute the object range for cᵢ, i.e., OR(cᵢ, Oᵢ^{K}), and use it to retrieve O^{C} as the set of objects from O^{S} that intersect with the object range OR(cᵢ, Oᵢ^{K}), such that for any query in cᵢ, the K nearest neighbours can be found in O^{C}.

Consequently, KNN queries performed in c; may be processed independent of other parts of O^{S} (i.e., O^{S}−O^{C}), which makes the KNN process genuinely scalable. An extra advantage of this approach is that the pre-computed object ranges may be stored along with the object dataset and re-used for different set of queries at a later time.

### Object Range for Spatial Data in Euclidean Space

As will now be described, given Euclidean space as an instance of metric space with Euclidean distance as its distance metric, object ranges as geometric entities may be computed for queries as line segments, triangles and polygons. In this respect, it will be understood that spatial data such as geospatial data may be represented in Euclidean space.

### Object Range for Query Points on a Line Segment

Given two points pₛ and pₑ in metric space (X, d), a line segment in X with the two points as its endpoints may be defined as an infinite point set:

$$L ( {p}_{s} , {p}_{e} ) = \{ p \vert d ( p , {p}_{s} ) + d ( p , {p}_{e} ) = d ( {p}_{s} , {p}_{e} ) : p ∈ X \} \qquad [ 12 ]$$

In particular. {p|p≠pₛ∧p≠pₑ} are the interior of L. It is worth noting that this is a definition of a line segment in generic metric spaces rather than being necessarily restricted to Euclidean space.

Given a candidate object set, O^{K}, which contains K objects from the object set O^{S}, for the Euclidean distance, the object range for a point p on L, OR^{E}(p∈L), can be defined as the disc centred at point p, with the distance from point p to the intersection point of the boundary of OR^{E}ₛ and OR^{E}ₑ as its radius, the following can be stated:

$${OR}^{B} ( p ∈ L ) ⊆ U ( {OR}_{s}^{E} = \{ p \vert d ( p , {p}_{s} ) \leq MaxDist ( {p}_{s} , {O}^{K} ) \} , \qquad [ 13 ]$$

$${OR}_{e}^{E} = \{ p \vert d ( p , {p}_{e} ) \leq MaxDis t ( {p}_{e} , {O}^{K} ) \} )$$

$$⋂ ( {OR}_{s}^{E} , {OR}_{e}^{E} ) ⊆ {OR}_{p}^{E} \qquad [ 14 ]$$

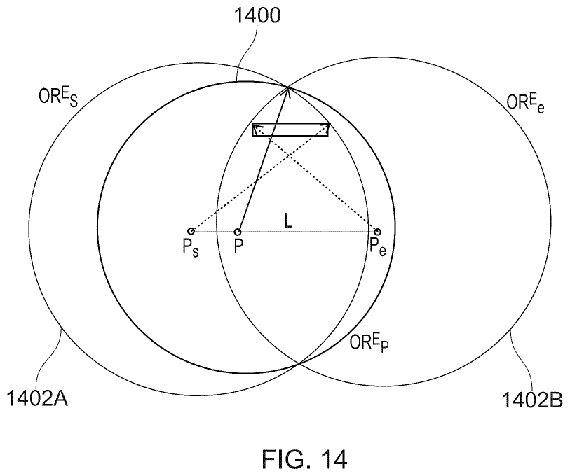

That is, as shown in FIG. 14, the object range 1400 of a point p on the line segment L, OR^{E}ₚ, is contained by the union of the extended object ranges 1402A and 1402B (i.e., extended object ranges OR^{E}ₛ and OR^{E}ₚ as described above) of the two endpoints, pₛ and pₑ, of the line segment L. On the other hand, OR^{E}ₚ contains the intersection of the two object ranges 1402A and 1402B.

Since, according to [10], the candidate object set O^{K}⊆∩(OR^{E}ₛ, OR^{E}ₑ), it can be concluded that O^{K}⊆OR^{E}ₚ, and hence OR^{E}ₚ is the object range 1400 for any query point p along the line segment L. As such, it follows that:

$$KNN ( p ∈ L , {O}^{S} ) ⊆ U ( {OR}_{s}^{E} , {OR}_{e}^{E} ) \qquad [ 15 ]$$

That is, the KNN for any point p on L is within the union of the object ranges of the two endpoints of L.

### Object Range for Query Points in a Triangle

Given three points p₁, p₂, and p₃ in X that are not collinear (i.e., d(p₁, p₂)+d(p₂, p₃)>d(p₁, p₃)), a triangle T(p₁, p₂, p₃) on X may be defined as:

$$T ( {p}_{1} , {p}_{2} , {p}_{3} ) = U ( L ( {p}_{1} , {p}_{2} ) , L ( {p}_{2} , {p}_{3} ) , L ( {p}_{3} , {p}_{1} ) , \{ p \vert ⋂ ( L ( {p}_{1} , p ) , L ( {p}_{2} , {p}_{3} ) ) = ∅ ∧ ⋂ ( L ( {p}_{2} , p ) , L ( {p}_{3} , {p}_{1} ) ) = ∅ ⋂ ( L ( {p}_{3} , p ) , L ( {p}_{1} , {p}_{2} ) ) = ∅ ∧ L ( {p}_{1} , p ) + L ( {p}_{2} , p ) < L ( {p}_{1} , {p}_{3} ) + L ( {p}_{2} , {p}_{3} ) ∧ L ( {p}_{2} , p ) + L ( {p}_{3} , p ) < L ( {p}_{2} , {p}_{1} ) + L ( {p}_{3} , {p}_{1} ) ∧ L ( {p}_{3} , p ) + L ( {p}_{1} , p ) < L ( {p}_{1} , {p}_{2} ) + L ( {p}_{3} , {p}_{2} ) \} ) \qquad [ 16 ]$$

In particular, the line segment between each of the three points, i.e., L(p₁, p₂), L(p₂, p₃), L(p₃, p₁), form the boundary of the triangle and the remainder the interior. Again, this is a definition of triangle in generic metric spaces.

Similar to the line segment case described with reference to FIG. 14, given a candidate object set, O^{K}, which contains K objects from the object set, O^{S}, for the Euclidean distance, the object range, OR^{E}(p), can be defined as the disc centred at a point p (p being a point within the triangle), with the largest distance to the three intersection points of the boundaries of OR^{E}₁, OR^{E}₂, OR^{E}₃ as its radius:

$$O {R}^{E} ( p ∈ T ) ⊆ U ( O {R}_{1}^{E} , {OR}_{2}^{E} , {OR}_{3}^{E} ) \qquad [ 17 ]$$

$$⋂ ( {OR}_{1}^{E} , {OR}_{2}^{E} , {OR}_{3}^{E} ) ⊆ {OR}_{p}^{E} \qquad [ 18 ]$$

$$KNN ( p ∈ T , {O}^{S} ) ⊆ U ( {OR}_{1}^{E} , {OR}_{2}^{E} , {OR}_{3}^{E} ) \qquad [ 19 ]$$

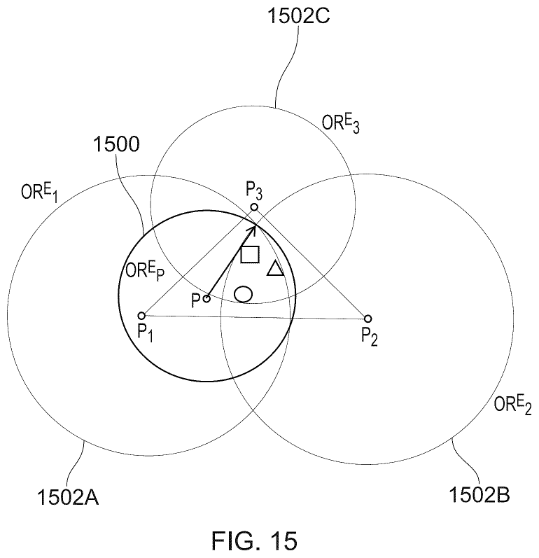

That is, as shown in FIG. 15, the object range 1500 of a point p within the triangle, T(p₁, p₂, p₃), is the union of the extended object ranges 1502A, 1502B and 1502C of its three vertices (i.e., points p₁, p₂, and p₃). As such, for any query point within the triangle, its K nearest neighbours can be found within the object range 1500 of the triangle. This principle can thus be extended to a polygon having any number of vertices.

### Object Range for Query Points in a Polygon

For a polygon P(p₁, p₂, . . . , pₘ) formed by the union of two or more edge-sharing triangles, the following applies:

$${OR}^{E} ( p ∈ P ) ⊆ U ( {OR}_{p \_ i}^{E} \vert i = 1 , m ) \qquad [ 20 ]$$

$$⋂ ( {OR}_{i}^{E} \vert i = 1 , m ) ⊆ {OR}_{p}^{E} \qquad [ 21 ]$$

$$KNN ( p ∈ P , {O}^{S} ) ⊆ U ( {OR}_{p \_ i}^{E} \vert i = 1 , m ) \qquad [ 22 ]$$

That is, similar to the example described with reference to FIG. 15, the object range of a polygon is the union of the extended object ranges of all its vertices. As such, for any query point within the polygon, the K nearest objects can be found within the object range of the polygon.

As such, statement [22] provides a method for computing the object range for queries in a polygonal region in query space.

Below are a few additional properties of the object range of polygons and line strings that may benefit practical implementations, in particular, enabling the object range to be more easily calculated. Let CH(P) be the convex hull of a polygon P, the following can be defined:

$${OR}^{E} ( P ) ⊆ {OR}^{E} ( CH ( P ) ) \qquad [ 23 ]$$

That is, the object range of a polygon is contained by the object range of its convex hull.

For a linestring LS(p₁, p₂, . . . , pₘ) that consists of several line segments, the following can be defined:

$${OR}^{E} ( LS ) ⊆ U ( {OR}_{p \_ i}^{E} \vert i = 1 , m ) \qquad [ 24 ]$$

$${OR}^{E} ( LS ) ⊆ {OR}^{E} ( CH ( LS ) ) \qquad [ 25 ]$$

That is, the object range of for query points on a line string is contained by the union of the object range of its vertices, as well as the object range for points on its convex hull.

### K-NN for Point Set Queries

Statement [5] states that for a multi-point query Q, its K-NN is in the union of the K-NN of all its constituent points, which are in the union of the object ranges of these points.

Given a polygonal region P in query space with K candidate objects, its object range may be defined as OR^{E}(P). Given a multi-point query Q⊆P:

$$KNN ( Q ) ⊆ {OR}^{E} ( P ) \qquad [ 26 ]$$

That is, the K-NN of Q is within the object range of P. Here Q may be a collection of discrete points, a linestring or multi-linestring, or a polygon or multi-polygon.

In the case that Q does not fall entirely in one polygonal region, for example, Q=U(∩(Q, P₁), N (Q, P₂)) extends over P₁ and P₂, the following can be defined:

$$KNN ( Q ) ⊆ U ( KNN ( ⋂ ( Q , {P}_{1} ) ) , KNN ( ⋂ ( Q , {P}_{2} ) ) ) \qquad [ 27 ]$$

That is, the K-NN of Q is in the union of K-NN object sets of its intersections with P₁ and P₂. This may be extended to cases where Q extends over more polygonal regions.

### Method of Pre-Processing Spatial Data for K-NN Queries

The method of pre-processing spatial data for K-NN queries will now be described with reference to FIG. 1. As noted above, the first step 1.2 in the pre-processing is to partition (also referred to as “covering” as described above) the query space (i.e., the region of the metric space where queries are to be performed), which may comprise a spatial dataset or part of a spatial dataset received from a data storage system 100, and allocate K candidate objects to each partition. In the following examples, it will be assumed the query space and object space are identical (i.e. queries are defined within the same spatial extent of the object set). However, it will be appreciated that the query space and the object space may not be the same and may be separated, as will be described further below.

As described above, the object range may be computed for a polygonal region in Euclidean space. By considering a polygonal region as a partition in the query space, an object range may be computed for each partition, as will be described further below, such that queries falling into different partitions can be processed in parallel.

The object range of a vertex is a disc which may be represented precisely by a mathematical equation, but this is not the case in a computer system, and so a polygon (e.g. a square or an octagon circumscribing the disc) is normally used in practical implementations.

The partitioning scheme used to partition the query space is selected based at least in part on the nature of the object set, for example, the distribution and number of objects within the object dataset, as well as the number and distribution of queries (if known). When given a partition of predefined size, it is preferable that its object range is relatively small so that fewer redundant objects will be retrieved and the query performance will be improved.

By definition, the size of the object range disc for each vertex depends on the MaxDist to the candidate object set. In general, if the candidate object set is compactly clustered and closer to the centre of the partition, the overall size of the object range for the partition will be minimised. Ideally, the query space is partitioned such that there are exactly K candidate objects in each partition which may be allocated to the partition without additional process, but in practice object selection and/or re-allocation may be required.

One approach could be to randomly assign K objects to each partition; however, this will result in impractically large object ranges that are very difficult, if not impossible, for a computer system to process. It is therefore better to allocate objects by proximal search or intersecting the object set with the partitions to obtain a more compact cluster of objects close to the centre of the partition to thereby minimise the object range.

For a uniformly distributed object set with M objects, a single-level regular grid of at most M/K cells will generate partitions each containing roughly K objects. If there are more than K objects allocated to a cell as a partition, the K objects that are closest to the centre of the cell may be selected. If there are fewer than K objects in a cell, extra objects from adjacent cells may be allocated to the cell. Such allocation requires a search structure to find adjacent cells. For a regular grid, such search structure may be implemented in an efficient way if the number of objects and partitions are relatively small.

For a non-uniform object distribution, which will often be the case when dealing with geospatial data, a quadtree (in case of 2D space) may be used to generate partitions in a hierarchical manner. Further details on the handling of a large dataset are provided below.

Both of the above schemes are space-based, regular partitioning. Alternatively, object-based irregular partitions may be used. One approach is to first perform a clustering process on the object set to create clusters of at least K objects and then create approximated Voronoi diagrams on the clusters as a partition. Here, approximation refers to the fact that an exact Voronoi diagram is not required, and the diagram boundaries may be significantly simplified to reduce the number of vertices on the boundary of partitions.

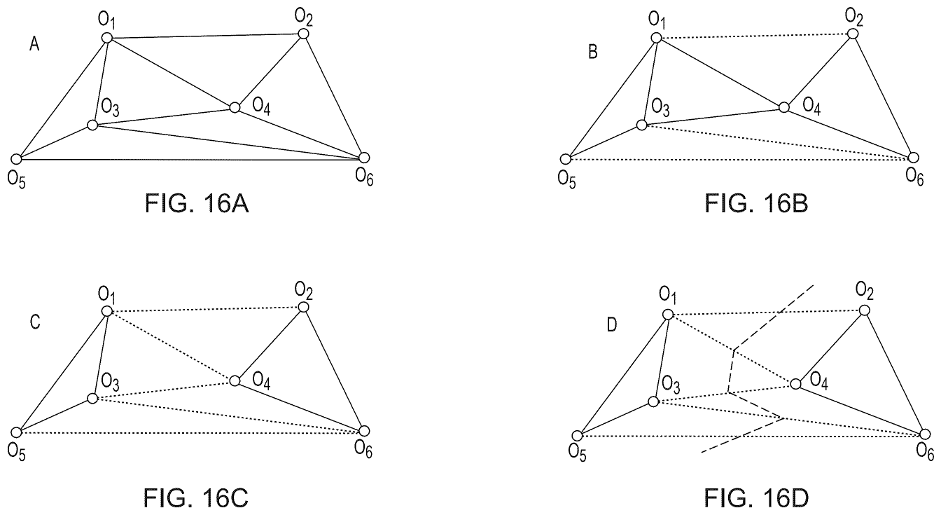

A practical method for such a clustering process in Euclidean space is to build a Delaunay triangulation on object points (using centroids for multi-point objects) and treat the triangulation as a graph, such as that illustrated in FIG. 16A, wherein edges are formed between groups of object points to form triangles. The longest edges are then recursively removed, as shown in FIGS. 16B and 16C, typically until further removal will result in a subgraph with less than K object points as nodes.

Each remaining subgraph is then a cluster for partitioning. The original Delaunay may then be used to create an approximated Voronoi diagram of the clusters, as shown in FIG. 16D. Whilst FIGS. 16A-D show a method where the object points are clustered into groups of three (i.e., K=3), it will be appreciated that any suitable clustering may be used.

After the initial object allocation, if there are more than K objects contained by a partition, the K objects closest to the centre of the partition will be selected as the candidate object set for this partition.

If there are fewer than K objects in a partition, adjacent partitions will be searched to find more objects until K objects are allocated to the partition. In this respect, an object could be part of the candidate object set for more than one partition, and thus the objects from adjacent partitions are not “re-allocated” but “double-allocated”. The information on partition adjacency may be obtained during the construction of the Voronoi diagram and stored along with the diagram to facilitate the re-allocation process.

### Handling of Very Large Object Set

The above described approaches are generally effective for smaller datasets, however, the partitioning of a query space becomes a lot more complex when very large object sets are involved, which is often the case with spatial data such as geospatial data.

In such cases, if a small number of larger partitions are generated, each partition corresponds to a larger subset of queries and a larger object range, that will retrieve a larger set of objects during the pre-processing and/or to perform subsequent K-NN queries. The dual demands on storage space for both objects and queries may well exceed the capacity of a processing unit in parallel computing environment (e.g., a computing node).

On the other hand, if a large number of smaller partitions are created, this could result in a lot of partitions that contain less than K objects. Consequently, a search structure for finding adjacent partitions usually has to be maintained to ensure that K objects are allocated to each partition, which may also exceed the capacity of the processing unit if the search structure covers the entire object set.

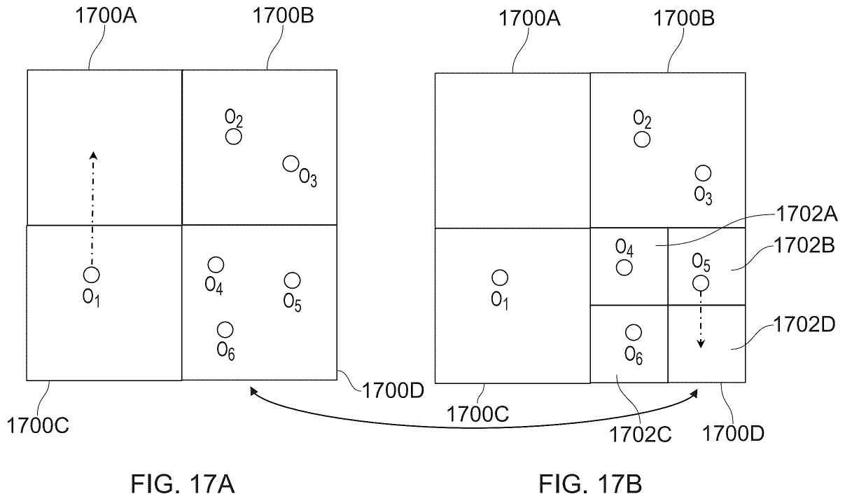

To eliminate the need to maintain a search structure for all partitions at all times, a top-down hierarchical approach to generating partitions is proposed, which will now be described with reference to FIGS. 17A-B. Here, a quadtree (on a 2D spatial dataset) is used as an example to demonstrate the method.

Firstly, as shown in FIG. 17A, an initial partition of the spatial extent of the whole object set (i.e., the area covered by the object set), {oᵢ|_{i=1.6}}, is performed. The number of partitions should be kept well within the capacity of the processing unit. In this example, the object set is partitioned into four initial partitions 1700A-D. One or more of the objects are then allocated into different partitions, first by containment (i.e., objects contained within the partition) and then by adjacency (i.e., objects are contained in adjacent partitions) until all partitions 1700A-D have at least K objects associated. In this respect, it will be appreciated that K may be any required number. In the present example, if K=1, all of the initial partitions have at least one object, except for the partition 1700A. A search structure is then required for maintaining information on partitions that are adjacent to each of the partitions 1700A-D. For partition 1700A, adjacent partitions 1700B-D are discovered from the search structure and objects in these adjacent partitions are retrieved. As the object of is the closest object to partition 1700A among these retrieved objects, it is allocated to partition 1700A by virtue of it its proximity. Since the number of partitions at the current level is restricted, the size of the search structure should be within the capacity limit and the memory it occupies will be released immediately after the object allocated to partition 1700A.

Next, as shown in FIG. 17B, if necessary, the same process is reapplied to create subdivisions as new partitions and allocate objects from the parent partition accordingly. Whether a partition should be sub-divided may be based on criteria such as the minimum number of objects in the partition and/or the spatial extent of the partition. For example, if we set the threshold for further partitioning to 3 or more objects in a partition, as shown in FIG. 17B, partition 1700D is sub-divided into four further partitions 1702A-D, but partitions 1700A-C are not sub-divided as they do not exceed the threshold of 3 or more objects. The objects, o₄, o₅ and o₆, of the partition 1700D are then allocated to the further partitions 1702A, 1702B and 1702C respectively by virtue of their containment within those further partitions. As the further partition 1702D does not contain any objects itself, the closest object, o₆, is also allocated to this further partition 1702D by virtue of its proximity, using a new search structure built on partitions 1702A-D When new partitions are created, their parent partition (e.g., partition 1700D) is removed from the partition list and any memory occupied by the parent partition will be released.

This process is then recursively repeated until no further partitioning is required according to the pre-set criteria.

Using this approach, whilst construction of an adjacent partition search structure may still be required for the sub-division of an individual partition, it will not be needed across the whole object set. Consequently, the risk of an oversized search structure is eliminated.

During this process, intermediate partitions may have a lot more than K objects associated with them, in which case, these intermediate partitions will be sub-divided further and the objects will be re-distributed to the new sub-divided partitions. For an intermediate partition with only K objects associated, it may still be necessary to create further sub-divided partitions due to conditions such as the maximum extent of a partition. In this respect, if a partition is spatially too big, this may result in too many query points within the partition, which may then exceed the processing capabilities of a computing node within the distributed or parallel computing system. In such cases, the same K objects may be assigned to each of the subdivided new partitions. In such cases of sub-division, a search structure would not be necessary as all of the new partitions will have the same K objects, and thus when querying one of the new partitions, it would not be necessary to search the adjacent partitions since this will output the same objects.

The hierarchical partitioning process may also apply to irregular partitions with a multi-level sampling scheme. In this respect, a small random sample is selected from the entire object set and an initial partition is built (e.g. using Voronoi diagram) on the sample object set. For each of the generated partitions in the form of irregular polygons, the sampling process is repeated recursively on all objects in a partition until the whole query space is partitioned with no less than K objects in each partition.

Frequently, the distribution of the object set is non-uniform but it still largely overlaps the query space. There are, however, some extreme cases where query space and object space do not intersect at all. An example of such case is where the object set comprises sea polygons (a zone of sea region off the coastline divided into multiple polygons), whilst the query locations comprise features on land (e.g., residential buildings).

In such cases, the hierarchical partitioning method is used. Otherwise, a conventional single-level partition scheme will spend most of the time performing an adjacency search due to the fact that most of the initial partitions (i.e., partitions of the land) will contain no intersecting objects (i.e., the sea polygons).

At step 1.4, once the query space has been partitioned and K objects have been allocated for each partition, the object range will be computed for each partition polygon, for example, using any of the methods described above. In this respect, the methodology employed will depend on the objects within the candidate object set. In this respect, if a partition is considered an infinite point set, it is not feasible to compute the object range for every point in the partition. How the object range is computed will therefore depend on the actual metric space involved. In 2D Euclidean space, the object range of a polygonal partition may be computed by way of the union of the object ranges of the vertices of the polygon boundary (whose number is finite).

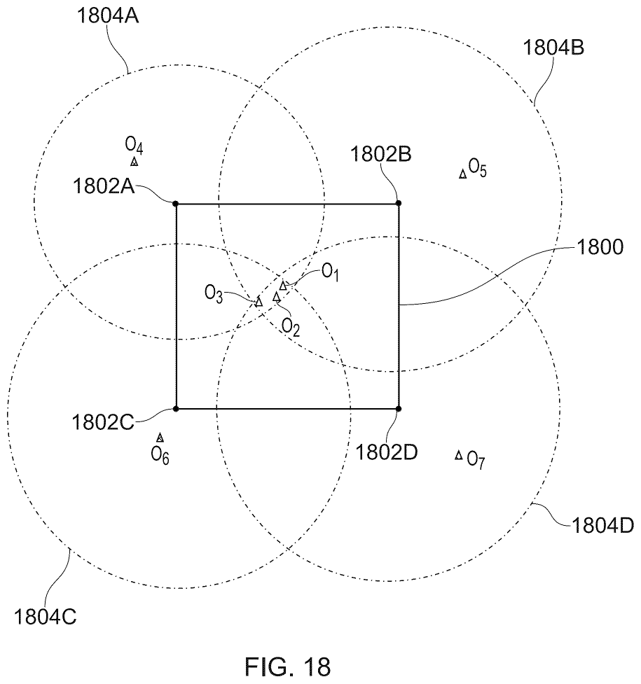

For example, as shown in FIG. 18, a spatial dataset (i.e., the query space) may have been partitioned using a grid system comprising cells of a given size. For example, in the context of geospatial data, the grid cells may be representative of a 1 km×1 km area of land. FIG. 18 illustrates one partition 1800 as an example, the partition 1800 comprising four vertices 1802A-D. At step 1.2, candidate objects o₁, o₂ and o₃ were allocated to the partition 1800, the candidate objects o₁, o₂ and o₃ being polygons represented by multiple points (i.e., the vertices of the polygons shown and the points along the line segments between those vertices). The object range (represented by the area enclosed by circles 1804A-D) of each vertex 1802A-D is then calculated based on the maximum distance between each vertex 1802A-D and the candidate objects o₁, o₂ and o₃, the maximum distance defining the radius of the object range 1804A-D. For example, the maximum distance from the vertex 1802A to the candidate objects o₁, o₂ and o₃ is the distance from the vertex 1802A to the furthermost point of object o₂. This distance thus provides the radius of the object range 1804A for vertex 1802A. A similar calculation is thus made for each of the vertices 1802A-D, with the object range of the whole partition 1800 being the union of these four object ranges 1804A-D. That is to say, the object range of the partition 1800 will encompass all of the object data contained within the object ranges 1804A-D. For example, the object range of the partition will also encompass objects o₄, o₅, o₆ and o₇, as well as o₁, o₂ and o₃. It will however be appreciated that further objects may also be contained within the object ranges 1804A-D and are not show here for simplicity. It will also be understood that the boundary of the union of the object ranges 1804A-D may also be simplified, for example, by using a circumscribed octagon.

At step 1.6. the pre-processed object range information for each partition is then stored as data for subsequent use in K-NN queries, for example, in the data storage system 100. In this respect, the object range information may comprise the computed object range and data associated with the respective partition. The object range information can be used on-the-fly to retrieve objects for the respective partition, which will guarantee that the K nearest neighbour of any query within this partition will be included in the object subset retrieved for this object range. For example, with reference to FIG. 18, the stored object range information may comprise the partition data (e.g., partition 1800) and the computed object ranges for each partition (e.g., object ranges 1804A-D). Additionally, or alternatively, the object set for the partition may be identified using the computed object range in the pre-process stage, and any retrieved objects may be stored with the object range information as object data. For example, with reference to FIG. 18, all of the objects (e.g., objects o₁ to o₇) contained within the object ranges 1804A-D may be stored for use in subsequent K-NN queries.

The pre-processing described above with reference to FIG. 1 supports k-NN queries from k=1 to K, where K is a positive integer given at the time of pre-processing. It will however be appreciated that, where k<K, the performance will be less effective due to extra objects involved to support a large K compared to an object range computed specifically for a smaller k.

One approach to addressing this is to compute multiple object ranges (k=1, K) for each partition and store all of the computed object ranges with the partition data. When a subsequent query is then performed, as will be described further below, the relevant object range will be identified for the given k and then used to retrieve the optimal object subset for that k.

An alternative approach is to compute multiple object ranges (k=1, K) for each partition, retrieve an object subset using each object range and store each object subset with the partition data. Each retrieved object may be labelled with the k associated with the object range that first retrieved that object (i.e., since some objects will be retrieved for a plurality of k values). When a subsequent query is then performed, k_{q}≥k may be used to filter out unnecessary objects. For example, given a K=5 and k_{q}=2, only objects labelled 1 or 2 will be retrieved.

### Method of Using Object Range to Perform K-NN Spatial Queries

As noted above, and shown in FIG. 2, the first step 2.2 in the method of performing K-NN spatial queries is to receive a request to perform a K-NN spatial query on the spatial dataset stored in the data storage system 100, wherein K nearest neighbours is to be computed in an object set for the query set (i.e., a plurality of query locations). As noted above, whilst the following discussion is concerned with a spatial data received from a data storage system 100, it will be appreciated that the query space may comprise any suitable type of metric data on which K-NN queries may be performed.

At step 2.4, data is received from the data storage system 100 and used to partition the query locations using the same partition framework used in the pre-processing step 1.2. In this respect, the data received may comprise the spatial data to be queried (i.e., the query space) and the partition data stored previously. It will of course be appreciated that the partition data and object range information described above with respect to the pre-processing method shown in FIG. 1 may also be stored on a different storage means to that of the spatial dataset. In this respect, a query may intersect with more than one partition, and therefore be included in the query sets of multiple partitions. In such cases, the query will be performed on each of these partitions, the results will be aggregated and re-processed. Further details will be given below.

At step 2.6, an object set is obtained for each partition based on the object range information stored at step 1.8 above, which may be stored in the data storage system 100 or on some other storage means. As described previously, the object range information may comprise the object range, which may be used to identify an object set on the fly. Alternatively, the object range information may comprise a pre-processed object set associated with that partition.

At step 2.8, for each query of the query set of a partition, a K-NN query can then be performed on the retrieved object set for the given partition. In doing so, only the objects associated with a partition based on the object range need to be queried to find the K nearest neighbours of the queries contained therein, thereby avoiding the need to perform K-NN queries on the entire object set, thus reducing the amount of processing power required to perform the K-NN query.

As will be described further below, the partitions may be distributed between the processors of a distributed or parallel computing system to perform the K-NN queries. By pre-processing the data in this way, the K-NN query can be performed across all of the query locations significantly faster. The amount of data to be queried by each processor (i.e., within the distributed or parallel computing system) is significantly reduced as only the objects within the object range of each partition need to be queried, thus enabling large scale K-NN queries to performed efficiently, whilst still guaranteeing an accurate set of results for each query.

For queries extending over multiple partitions, for example, using statement above, the returned results will be collated for output, and any duplicated results from different partition are removed. If there are more than K objects left in the deduplicated object set, all objects will be re-ranked according to their distance to the query and the nearest K objects are selected as the final result for this query. That is to say, if the processing of two or more partitions results in more than K objects for a given query location, the distances of those objects will be compared to find the actual K-NN objects for that query location.

At step 2.10, the results of the K-NN spatial query may then be output to the user. These results may be output to the user in any suitable way, for example, in a table format, or a graphical format (e.g., as a map).

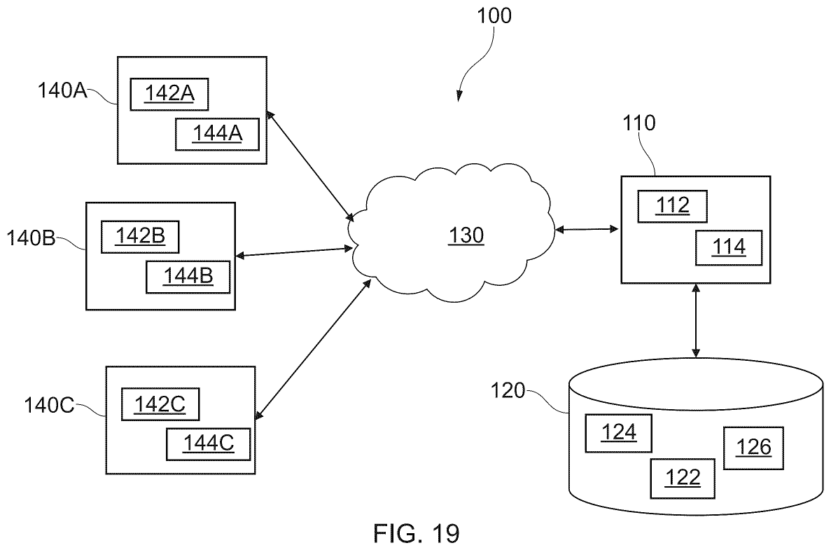

FIG. 19 illustrates one example of a distributed computing system used to implement the methods described in detail above, and reference should be made to the above when considering the various steps and processes described below.

FIG. 19 shows a distributed computing system 100 comprising a server 110 in communication with a plurality of computing nodes 140A-C via a network 130 through a communications interface 112. The server 110 comprises a processor 114 arranged to carry out computing operations, and is also in communication with a core server 120. The core server 120 runs different software implemented modules which carry out different tasks or provide particular data when required by the processor 114. More specifically, a data storage system 122 storing the object dataset on which queries are to be performed. For example, the data storage system 122 may store spatial data, or more specifically, geospatial data. The data storage system 122 may also store the partition data and object range data obtained during the pre-processing described with reference to FIG. 1, or alternatively, said data may be stored on some other storage means. A K-NN pre-processing module 124 may be arranged to carry out the necessary steps to pre-process the data for use in K-NN queries, as described above with reference to FIG. 1. When a K-NN request is received by the server 110 (e.g., via the network 330), a K-NN query module 126 may be arranged to partition the query locations using the dataset and partition data stored in the data storage system 122 and obtain the object set for each partition using the object range information stored in the data storage system 122, as described above with reference to steps 2.4 and 2.6 of FIG. 2. It will also be appreciated that the pre-processing described with reference to FIG. 1 and/or the steps 2.4 and 2.6 described with reference to FIG. 2 may also be performed by the computing nodes 140A-C. For example, the computing nodes 140A-C may be arranged to calculate the object range information for each partition. Similarly, the computing nodes 140A-C may be used to partition the query locations and obtain the object set for each partition using the object range information.

Once the query locations have been partitioned and the object set for that partition identified, the server 110 is arranged to send the query data and object data associated with one or more partitions to a computing node 140A-C via the network 130 for processing. In this respect, each computing node 140A-C may comprise a memory 142A-C, or other non-transitory device, storing computer readable instructions that when executed cause a processor 144A-C to perform a K-NN query on the one or more partitions received from the server 110. Once the K-NN query has been performed, the results of the K-NN query are sent back to the server 110 for collating and outputting to a user.

Whilst three computing nodes 140A-C are shown, it will of course be appreciated that the distributed computing system 100 may comprise any number of computing nodes. Partitions will then be sent to as many computing nodes 140A-C as are needed to perform the K-NN query across the whole dataset. In this respect, it will be understood that each computing node 140A-C within the distributed computing system 100 may receive multiple partitions for processing, with the partitions being processed in sequence by the respective computing node 140A-C.

Additionally, whilst the K-NN pre-processing module 124 and K-NN query module 126 are shown as being provided on the same core server 120, it will of course be appreciated that the pre-processing of FIG. 1 may be carried out on a separate computing system, the results then being sent to the core server 120 for storing in the data storage system 122, or in response to a request from the server 110 when a K-NN query request is received.

It will also be appreciated that aspects described herein may be similarly implemented on a parallel computing system. In such cases, the computing nodes 140A-C will be replaced by a single computing entity comprising multiple processors. As such, it will be understood that the K-NN queries will be performed by a plurality of processing means, wherein the processing means comprise the processors of a plurality of computing nodes connected by a network (i.e., a distributed computing system) or the processors of a single computing system (i.e., a parallel computing system).

A number of examples of aspects described herein in use will now be described.

### Example 1

With reference to FIGS. 1 and 2, an example will now be described in which both the object set and the query set comprises a plurality of geospatial data points.

In this example, the object set comprises data points representative of postcodes in Great Britain (over 1.73 million). As such, in this example, the query space and the object space comprise geospatial data representative of the land mass of Great Britain.

To pre-process the geospatial data, it is first partitioned with K candidate objects being allocated to each partition (step 1.2).

For example, the geospatial data (i.e., the query space) may be partitioned using a grid system of 1 km×1 km square cells, since post codes data points are typically distributed in a relatively even manner. Consequently, a partition as a grid cell takes the form of a square with four corner points (i.e. vertices). As only geospatial data relating to GB land is required, any grid cells not intersecting with GB land polygons (e.g., sea polygons, land polygons associated with other countries) are omitted.

The object set is spatially joined with the grids to give each partition (i.e., a grid cell) an initial object set for object range computation. For example, K=3 candidate objects may be allocated to each partition, on the basis that there are typically no more than 3 postcodes within a 1 km² area of a densely populated town or city. For any partitions where there are less than K objects, an expanding ring search is performed to acquire extra objects from adjacent partitions until K is reached for every partition. A search structure is maintained for the relevant partitions to ensure efficient retrieval of adjacent partitions.

The object range for each partition is then computed (step 1.4). For example, the K objects closest to the centre point of the grid cell are selected to compute the object range for each partition. In this respect, the object ranges of a corner point of the grid cell polygon is computed as the disc centred at the corner point with the MaxDist from the corner point to the furthest object in the K objects as radius. The object range of a grid cell as a partition will be thus the union of the object ranges of the four corner points as described above.

For each partition, the object range information and the partition geometry will be stored (step 1.6) for use in subsequent K-NN queries, wherein the object set comprises GB postcodes.

If a request is then received (step 2.2) to find the nearest two postcodes (i.e., k=2) to every address in Great Britain (i.e., each query location is a data point representative of addresses in Great Britain, which equates to around 40 million query locations), the query locations will then be partitioned using the same partition scheme as that performed during pre-processing (step 2.4). That is to say, the geospatial data will again be partitioned into 1 km×1 km square cells, wherein each partition will have one or more query locations.

The object range information computed at step 1.4 will then be retrieved and used to obtain the object set for each partition (step 2.6). In this respect, any data point representative of a postcode and intersecting the object range geometry are retrieved to form the object set for this partition.

As described above, all query sets and the associated object sets of the partitions may then be transmitted to a plurality of distributed computing nodes or a parallel computing system, where the K-NN query is performed (step 2.8) on each respective partition to find the 2 nearest objects (i.e., postcodes) to each query location (i.e., address) within the partition.

The results of the K-NN query will then be output to the user (step 2.10), for example, in a table or other visual representation (e.g., a map).

By pre-processing the geospatial data in this way, the K-NN query can be performed across all of the query locations significantly faster. The amount of data to be queried by each processor (i.e., within the distributed or parallel computing system) is significantly reduced, thus enabling large scale K-NN queries to performed quickly (in the order of minutes) and without requiring significant processing power, whilst still guaranteeing an accurate set of results for each query.

### Example 2

An example will now be described in which both the object set and the query set comprises a plurality of geospatial polygons (i.e., comprising multiple data points).

In this example, the object set comprises polygons representative of an area of vegetative land cover (e.g., fields, parks, areas of grass etc.) in Great Britain (approximately 150,000).

As before, the geospatial data (i.e., the query space) is first partitioned with K candidate objects being allocated to each partition (step 1.2).

For example, the geospatial data may again be partitioned by a grid system of 1 km×1 km square cells. The object set is spatially joined with the grids to give each partition (i.e., a grid cell) an initial object set for object range computation. For example, K=5 candidate objects may be allocated to each partition.

The object range for each partition is then computed for each partition (step 1.4). For example, the K objects closest to the centre point of the grid cell are selected to compute the object range for each partition. In this respect, the object ranges for a corner point of the grid cell polygon is computed as the disc centred at the corner point with the MaxDist from the corner point to the furthest object in the K objects as its radius. The object range of a grid cell as a partition will thus be the union of the object ranges of the four corner points as described above.

For each partition, the object range information and the partition geometry will be stored (step 1.6) for use in subsequent K-NN queries, wherein the object set comprises polygons representative of an area of vegetative land cover.

If a request is then received (step 2.2) to find the nearest three areas of vegetative land cover (i.e., k=3) to every building in Great Britain (i.e., each query location is a polygon representative of a building, which equates to around 14.5 million query locations), the query locations will then be partitioned using the same partition scheme as that performed during pre-processing (step 2.4). That is to say, the geospatial data will again be partitioned into 1 km×1 km square cells, wherein each partition will have one or more query locations.

However, one of the challenges with queries involving polygon query locations is that the object range computed for a partition only supports query inside the partition, whereas polygon query locations may extend outside the partition and intersect with several adjacent partitions.

One approach to handle such situation is to assign a unique identifier for each query and spatially join the query locations with the partitions to allocate query locations for each partition, wherein some polygon query locations will be joined to multiple partitions, for example, in the case where they intersect the geometries of multiple partitions.

As before, the object range information computed at step 1.4 will then be retrieved and used to obtain the object set for each partition (step 2.6), with the query set and associated object set of each partition then be transmitted to a plurality of distributed computing nodes or a parallel computing system to perform the K-NN query (step 2.8) on each respective partition. Using this approach, for some polygon query locations, multiple sets of results will be returned for one query location, wherein each set of results reflects the K-NN query on a particular partition and the object set for that partition.

As such, the results will first be processed to remove any duplicate results (i.e., the same query-object pair). The results will then be grouped using the query identifier and the distances between each query location and object pair to re-rank the object to get the KNN for each query location. That is, by using the query identifier, it will be possible to identify any results that are associated with the same query location, but have been processed as part of different partitions. Each set of results for each query location can thus be compared to remove any duplicates and their distances ranked to give the final set of K-NN objects. For example, a query location processed as part of two different partitions may generate a first set of K objects comprising object 1, object 2 and object 3, and a second set of K objects comprising object 1, object 2 and object 4. These two sets of results may then be compared so as to first remove the duplicate objects 1 and 2, and then the distances of objects 3 and 4 compared to determine which is the third nearest neighbour to the query location.

The results of the K-NN query will then be output to the user (step 2.10), for example, in a table or other visual representation (e.g., a map).

### Performing KNN Queries on a Network

The following discussion provides details of how the invention described herein may be used to process network K-NN queries at scale.

A network of nodes and links can be represented as a graph. The terms network, node and link can be considered equivalent to graph, vertex and edge, respectively, in graph theory.

A network has a natural metric of the shortest path distance between any two points on the network. However, in practice it is common that the path is directional, i.e., d(a, b)≠d(b, a), which violates one of the basic properties of metric space. Initially, d(a, b)=d(b, a) will be assumed, and the directional issue will be addressed later.

### The Network K-NN Problem

A network K-NN problem may be defined as: given a network G (N, L) with N as the node set and L as the link set, N^{O}⊂N as the object node set and Q^{O}⊂N as the query node set, for each q∈Q^{O}, find the K nearest neighbours in N^{O} by shortest path distance. A node may be an object node, or a query node, or both an object node and a query node.

A network may not necessarily be fully connected. There may not be a path from one node to another node in the network. In such cases, the network may be divided into several components (also referred to as connected components). Each component as a sub-network is fully connected but there is no connection between any two components. The below discussion does not require a network to be divided into components, but it can be assumed that a component contains at least K object nodes, although cases with less than K object nodes can be handled easily.

It is also assumed that all query locations are nodes on a network. In practice, however, they could also be points or intervals on links. Such cases, however, may be converted to the node case. Given a link I with end nodes nₛ and ne, for any location p on 1, the following can be stated:

$$KNN ( p , {N}^{o} ) ⊆ U ( KNN ( {n}_{s} , {N}^{O} ) , KNN ( {n}_{e} , {N}^{O} ) ) \qquad [ 28 ]$$

That is, the K-NN for a location on a link may be derived from the K-NNs for the two end nodes of the link. This also applies to intervals on a link.

### Object Range for a Network Node

Given a query node nq and a set of object nodes NO-K, the object range may be defined in a similar way as that described above. The following definitions will be used throughout the following discussion:
G.Nodes: node set of network G
G.Links: link set of network G
SD(n₁, n₂): the shortest path distance from a node n₁ to a node n₂
SD(n, 1): the smaller value of the shortest path distance from a node n to the two end nodes of a link 1
Node (L): all nodes connected by links in link set L
Link(N): all links connected to nodes in node set N
G.BFS_KNN (n, K): the sub-network generated by a Breadth-First style search from node n until K nearest nodes are found or the whole network is searched. It contains the shortest paths from the node to the K object nodes as well as other paths searched in the process.

The object range of a query node nq is defined with respect to object node set N^{O_K} as:

$${OR}_{N e t} ( {n}_{q} , {N}^{O \_ K} ) = G ( {N}_{OR} , {L}_{OR} ) \qquad [ 29 ]$$

$$where {L}_{OR} = \{ 1 \vert SD ( {n}_{q} , 1 ) \leq sup ( SD ( {n}_{q} , n ∈ {N}^{O \_ K} ) and {N}_{OR} = Node ( {L}_{OR} )$$

That is, the graph of all links within the maximum shortest path distance from nq to nodes in N^{O_K}, and all nodes on these links. Here it is assumed that n_{q} and N^{O_K} are in the same component so they are connected.

A big difference between a network and Euclidean space is that a network is discrete. In general cases of a network with multiple components, it is not guaranteed that a node and a randomly provided object node is connected. On the other hand, the number of paths between a query node and an object node are finite, and nodes on the path have inter-dependency. For these reasons, the object range of a network node may be defined in an alternative way:

$${OR}_{N e t} ( {n}_{q} , K , {N}^{O} ) = G . BFS\_KNN ( {n}_{q} , K ) \qquad [ 30 ]$$

That is, the candidate object set is not provided but discovered by a breadth-first style search process. In fact, if the K-NN object nodes for the query node is known and definition [30] is applied, the same sub-network is found.

### Network Partition and Boundary Nodes

A network G (N, L) may be partitioned into several sub-networks {Gᵢ(Nᵢ, Lᵢ)|₁=1, n}.

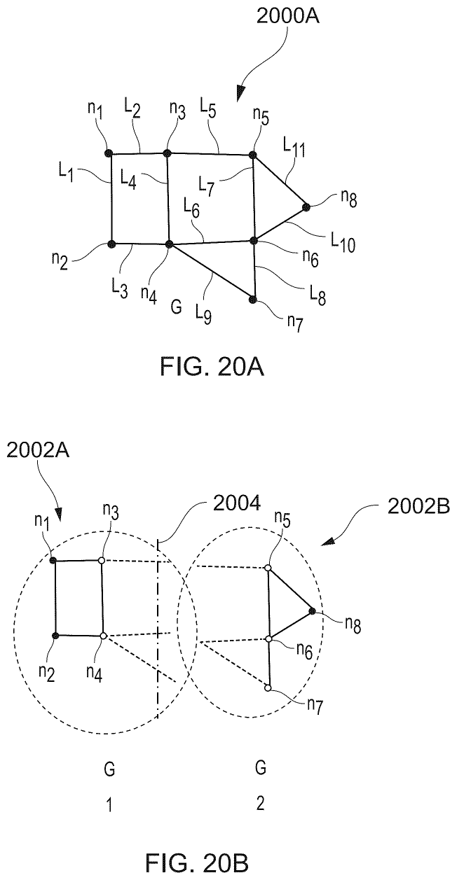

FIG. 20A illustrates a first network 2000A comprising a plurality of nodes n₁₋₈ with links l₁₋₁₁ therebetween. FIG. 20B illustrates a conventional approach of partitioning the network into two sub-networks 2002A-B having a partition boundary 2004. In particular, nodes n₃₋₇ are boundary nodes, which are nodes of links connecting two sub-networks. The other nodes in the sub-network are internal nodes. Links connecting boundary nodes in two sub-networks, i.e., l₅, l₆ and l₉, are regarded as boundary links. These boundary links are not included in any sub-networks partitioned by the conventional method, as shown in FIG. 20B.

For practical reasons, which will be discussed further, sometimes it is helpful to include the boundary links in sub-networks, as illustrated in FIG. 20C. Furthermore, there may be cases where a boundary node appears in two sub-networks, as illustrated by FIG. 20D.

It is thus clear that the boundary nodes “shadow” the internal nodes of the sub-network.

Consequently, it can be said that a path from nᵢₙₜ, an internal node of a sub-network to a node nₑₓₜ in another sub-network will pass at least one boundary node n_{bnd}. If the path is the shortest path between nᵢₙₜ and nₑₓₜ, it overlaps the shortest path between n_{bnd} and nₑₓₜ.

In fact, a path to another internal node may also pass a boundary node of the sub-network.

### Object Range for a Sub-Network

Given a sub-network Gᵢ(Nᵢ, Lᵢ) of a network G(N,L) with Nᵢ^{N} as its boundary node set, and N^{O} as its object node set, the object range for a sub-network is defined as:

$${OR}_{net} ( {G}_{i} , K , {N}^{O} ) = U ( G , \{ {OR}_{net} ( {n}_{j} ∈ {N}_{i}^{N} , K , {N}^{O} ) : j = 1 , m \} ) = U ( G , \{ G . BFS\_KNN ( {n}_{j} ∈ {N}_{i}^{N} , K ) : j = 1 , m \} ) \qquad [ 31 ]$$

That is, the object range of a sub-network is a network which is the union of the sub-network and the object ranges of all its boundary nodes. Here the union operation merges node sets and link sets of two or more sub-networks respectively to form a new network.

Subsequently, for object set N^{O}⊂N, the following is defined:

$$KNN ( n ∈ N , {N}^{O} ) ⊆ {OR}_{net} ( {G}_{i} , K , {N}^{O} ) . Nodes \qquad [ 32 ]$$

That is, for any query node in the sub-network, its network K-NN may be found in the object range of the sub-network as in definition [31].

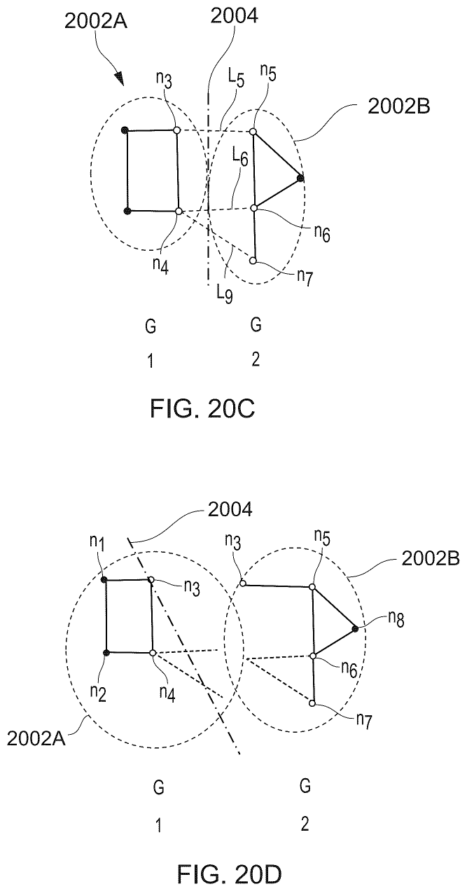

Based on [30], the object range for a sub-network may be further simplified. As shown in FIG. 21, if a K-NN object node (nₒ) for a boundary node (n_{bnd}) is outside the sub-network 2100, only the nodes (i.e., n₁) and links on the shortest path (i.e., links l₁ and l₂ from n_{bnd} to nₒ) to the object node no need to be included in the object range for the sub-network 2100, and all other nodes and links discovered during the BFS search can be omitted.

As described above, multiple candidate object sets can be used to create a compact object range of a sub-network (indeed, one set per boundary node). This is possible mainly due to the discrete and finite nature of networks.

The use of breadth-first style search implies that potentially efficient access to the whole network may be required during the pre-process stage depending on the partitioning strategy chosen. In cases where there is less than K object nodes in a component, the whole component will be searched.

The object range of a partitioned sub-network is a discrete and finite structure with a limited number of nodes. Consequently, it is possible to pre-compute and store the KNN for all nodes in the partition. At query time, queries on nodes may be answered immediately; queries associated with locations on a link may also be answered efficiently using (i.e., via the K-NNs of the two nodes of the link).

As already stated, the discussion in this section assumes that all links are un-directional (hence metric space properties are met). Also, all objects and queries are on existing nodes in the network, and thus it is possible to partition the network to create sub-networks without boundary links (as shown in FIG. 20D).

### Example 3—K-NN on Spatial Network

A spatial network is a graph whose nodes and links are point sets with locations defined in coordinate systems in Euclidean space. Consequently, these links and nodes may be selected by spatial queries.

Similar to the above, a spatial network K-NN problem is defined as: given a network G (N, L) with N as the node set and L as the link set, N^{O}⊂N as the object set and Q={qᵢ∈lⱼ|qᵢ∈Q, lⱼ∈L} as the query set in the form of a set of locations on L, for each q∈Q, find the K nearest neighbours in N^{O} by shortest path distance.

By definition, each query location q is not necessarily on a node. The reason locations on links rather than nodes in a network are used as query locations is to better support spatial partition of networks, as well as queries with arbitrary spatial locations that are not on existing nodes in the network.

An example of such scenarios is a road network and address points. Address points are not on the network itself, however, a location on the network can be assigned for each address (e.g., by proximity). For the purposes of the following example, it is assumed that the assignment of each query location on the links is performed in a separate process. Indeed, this assignment process itself may be a nearest neighbour query to which the methods described herein may be applied.

To pre-process the spatial network, as described with reference to FIG. 1, the spatial network is partitioned with K candidate objects being allocated to each partition (step 1.2).

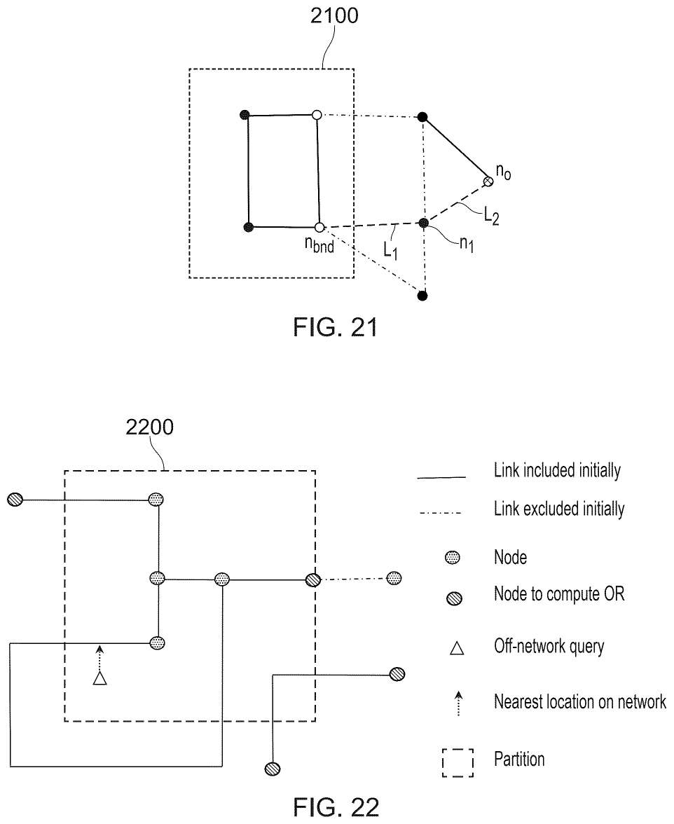

With the locations of nodes and links in a spatial network, it may be partitioned by any spatial partition scheme (e.g., a regular grid), for example, as illustrated by the partition 2200 in FIG. 22. Given a partition geometry, all nodes and links intersecting the partition 2200 will be collected. In this respect, nodes of the collected links, even if outside the partition 2200, are also collected (FIG. 19).

This also includes the case where both nodes of a link are outside the partition 2200, but the interior of the link intersects with the partition 2200. This case is due to the spatial intersection between partition and links.

It will be appreciated that FIG. 22 shows only one partition 2200 but that there will be further partitions adjacent thereto. It will thus be apparent that some nodes and links may appear in the sub-network of more than one partition.

After the spatial network is partitioned, with nodes and links associated with each partition 2200, the object range for each partition is computed (step 1.4).

As discussed above, if all boundary nodes are on the boundary of the spatial partition, definition can be applied directly. A simple solution to facilitate this is to add new nodes on intersections between boundary links (including the special case described above) and partition boundaries. This will, however, involve further modification to the original dataset which may not always be desirable.

An alternative solution is to slightly enlarge the object range. In brief, for nodes on a partition boundary, compute their object range; for a boundary link, compute the object range for the node outside the partition; and for the special case where links intersect the partition but both nodes are outside, compute the object range for both nodes.

In more detail, for each partition, all intersecting nodes and links are identified to create the initial sub-network.

The nodes for object range computation are identified by one of the two methods described above, and the object range computed for each of them via a breadth-first network search process.

The computed node object range is merged with the initial sub-network to form the final object range for the partition (in the form of a network).

As before, the computed object range for each partition may then be stored (step 1.6) for use in subsequent K-NN queries. Alternatively, as the spatial network comprises a discrete set of query locations and objects, the K-NN for all nodes inside the partition may be pre-computed and stored.

For spatial networks, there are two options for storing object range information. All the links and nodes in the object range sub-network may be stored along with the partition. Alternatively, due to the spatial nature of the network, the convex hull (or the concave hull) of all nodes and links in the object range sub-network may be computed, and the hull geometry stored with the partition. When a query is to be performed, the hull geometry may be used to retrieve the nodes and links of the object range via spatial query.

A more extreme approach is to pre-compute K-NN for all nodes contained by the partition (e.g., using a Floyd-Warshall algorithm for finding shortest path distance between all pairs of nodes in the object range sub-network). If the identities of the K-NN object nodes are all that's need, the required additional storage is minimal and it is not necessary to store the object range at all.

To process K-NN queries in a partition, the method described with reference to FIG. 2 is substantially followed once more.

As before, the spatial network is partitioned using the same partition scheme as the pre-processing (step 2.4), and the stored object range links and nodes for each partition are retrieved (step 2.6). Alternatively, as described above, the hull geometry of the object range may be used to retrieve all links and nodes.

A graph using the links and nodes retrieved for each partition is built, and a preferred shortest path algorithm used to compute the K-NN for each query location.

If the K-NN for all nodes are pre-computed, it is only necessary to retrieve the links intersecting a partition and the nodes of these links. Definition may then be applied to get K-NN for any query location that is associated to a link intersecting the partition.

### Directed Network Links

Whilst the above discussion relates to un-directional network links in order to satisfy the property of a metric space, this restriction may be relaxed for many applications that demands shortest path distance on one direction only (i.e., from a query location to an object node).

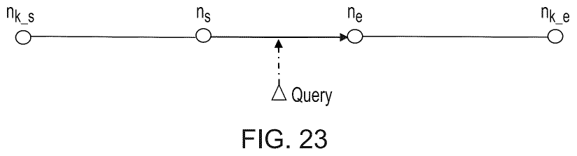

As shown in FIG. 23 where n_{k_s} and n_{k_e} are object nodes, the link I(nₛ, nₑ) is a directed link (from nₛ to nₑ only). For a query associated to the link, its K-NN is the same as K-NN(nₑ)=n_{k_e} rather than being selected from the union of KNN(nₛ) and KNN(nₑ) since there is no path from the query location to n, without passing nₑ.

What is claimed is:

1. A computer-implemented method of performing K-nearest neighbour (K-NN) queries on a spatial dataset in a distributed or parallel computing system, the distributed or parallel computing system comprising a plurality of processing means, and the spatial dataset comprising a query dataset and an object dataset, wherein the method comprises:
receiving instructions to perform a K-NN query on the spatial dataset to find a set of k-NN objects for a plurality of query locations of the query dataset, wherein k is an integer value greater than or equal to one;
generating a plurality of partitions of the query dataset according to a first partition scheme;
determining, for each partition, a set of objects to be queried from the object dataset based on pre-processed object range information associated with the partition, wherein the pre-processed object range information is determined using the first partition scheme and K a predetermined number of candidate objects allocated to each partition, wherein K is an integer value greater than or equal to the integer value of k;
distributing the plurality of partitions and the respective sets of objects to be queried between the plurality of processing means to perform the K-NN query, wherein each processing means processes one or more partitions to determine a set of k-NN objects associated with each query location of a partition;
receiving one or more sets of k-NN objects from each processing means; and
collating the one or more sets of k-NN objects from each processing means for output.

2. The computer-implemented method according to claim 1, wherein the plurality of partitions are generated such that each partition comprises at least one query location; and,
wherein generating the plurality of partitions comprises receiving pre-processed partition data for the query dataset, wherein the pre-processed partition data comprises the plurality of partitions.

3. A computer-implemented method according to claim 1, wherein the pre-processed object range information comprises the set of objects to be queried for each partition.

4. The computer-implemented method according to claim 1, wherein the pre-processed object range information comprises an object range for each partition, the object range comprising one or more areas of the spatial dataset, each area being enclosed by a circle having a radius calculated based on the maximum distance between a vertex of a boundary of the partition and K candidate objects allocated to the partition.

5. The computer-implemented method according to claim 4, wherein the method further comprises pre-processing the spatial dataset to determine the object range of each partition, wherein the pre-processing comprising:
identifying each vertex of the boundaries of the partition;
allocating K candidate objects to the partition;
calculating, for each vertex of the partition boundary, an area being enclosed by a circle having a radius calculated based on the maximum distance between the vertex and the K candidate objects; and
determining the object range of the partition based on a union of the area calculated for each vertex of the partition boundary.

6. The computer-implemented method according to claim 4, wherein determining the set of objects to be queried for each partition comprises identifying the objects within the area calculated for each vertex of the partition boundary.

7. The computer-implemented method according to claim 1, wherein collating the one or more sets of k-NN objects comprises:
identifying a query location processed within two or more partitions, such that two or more sets of k-NN objects are received;
removing any duplicate k-NN objects contained within the two or more sets of K-NN objects; and
ranking the remaining k-NN objects in dependence on a distance from the query location and each k-NN object to thereby provide a final set of K-NN objects for the query location.

8. The computer-implemented method according to claim 1, wherein the first partition scheme comprises one of: a grid system, a quadtree or a Voronoi diagram.

9. The computer-implemented method according to claim 1, wherein the spatial dataset comprises geospatial data representative of a geographical region.

10. The computer-implemented method according to claim 1, wherein the query dataset and object dataset each comprise one or more of: one or more data points, one or more line segments, and/or one or more polygons.

11. A system for performing K-nearest neighbour (K-NN) queries on a spatial dataset, the spatial dataset comprising a query dataset and an object dataset, wherein the system comprises:
a processor; and
a computer readable medium storing one or more instruction(s) arranged such that when executed the processor is caused to:
receive instructions to perform a K-NN query on the spatial dataset to find a set of k-NN objects for a plurality of query locations of the query dataset, wherein k is an integer value greater than or equal to one;
generate a plurality of partitions of the query dataset according to a first partition scheme;
determine, for each partition, a set of objects to be queried from the object dataset based on pre-processed object range information associated with the partition, wherein the pre-processed object range information is determined using the first partition scheme and K a predetermined number of candidate objects allocated to each partition, wherein K is an integer value greater than or equal to the integer value of k;
distribute the plurality of partitions and the respective sets of objects to be queried between a plurality of processing means of a distributed or parallel computing system to perform the K-NN query, wherein each processing means processes one or more partitions to determine a set of k-NN objects associated with each query location of a partition;
receive one or more sets of k-NN objects from each processing means; and
collate the one or more sets of k-NN objects from each processing means for output.

12. The system according to claim 11, wherein the system further comprises only one of:
a distributed computer system comprising a plurality of computing nodes, wherein the plurality of partitions are distributed between the plurality of computing nodes, or
a parallel computing system comprising a plurality of processors, wherein the plurality of partitions are distributed between the plurality of processors.

13. A computer-implemented method of pre-processing a spatial dataset for use in K-nearest neighbour (K-NN) queries to be performed in a distributed or parallel computing system, the spatial dataset comprising a query dataset and an object dataset, wherein the method comprises:
generating a plurality of partitions of the query dataset according to a first partition scheme;
allocating, to each partition, K candidate objects from the object dataset, wherein K is an integer value greater than or equal to one;
determining an object range for each partition, the object range of each partition comprising one or more areas of the spatial dataset, each area being enclosed by a circle having a radius calculated based on a maximum distance between a vertex of a boundary of the partition and the K candidate objects; and
storing object range information for use in K-NN queries of the spatial dataset, the object range information at least comprising the object range determined for each partition.

14. The computer-implemented method according to claim 13, wherein determining the object range for each partition further comprises:
identifying each vertex of the boundaries of the partition;
calculating, for each vertex of the partition boundary, an area being enclosed by a circle having a radius calculated based on the maximum distance between the vertex and the K candidate objects; and
determining the object range of the partition based on a union of the area calculated for each vertex of the partition boundary.

15. The computer-implemented method according to claim 13, wherein the allocating K candidate objects comprises allocating a predetermined number of candidate objects to each partition based on containment within the partition and/or adjacency to the partition.

16. The computer-implemented method according to claim 13, wherein storing object range information further comprises storing the plurality of partitions as partition data; and optionally,
wherein storing object range information further comprises storing object data for use in K-NN queries, the object data comprising one or more objects contained within the area of the spatial dataset defined by the object range of each partition.

17. The computer-implemented method according to claim 13, wherein the method further comprises determining a plurality of object ranges for each partition based on two or more sets of K candidate objects for each partition, each set of K candidate objects comprising a different number of objects.

18. The computer-implemented method according to claim 13, wherein the first partition scheme comprises one of: a grid system, a quadtree or a Voronoi diagram.

19. The computer-implemented method according to claim 13, wherein the spatial dataset comprises geospatial data representative of a geographical region; and optionally
wherein the object dataset comprises one or more of: data points, line segments and polygons.

20. A system for pre-processing a spatial dataset for use in K-nearest neighbour (K-NN) queries to be performed in a distributed or parallel computing system, the spatial dataset comprising a query dataset and an object dataset, the system comprising:
a processor; and
a computer readable medium storing one or more instruction(s) arranged such that when executed the processor is caused to:
generate a plurality of partitions of the query dataset according to a first partition scheme;
allocate, to each partition, K candidate objects from the object dataset, wherein K is an integer value greater than or equal to one;
determine an object range for each partition, the object range of each partition comprising one or more areas of the spatial dataset, each area being enclosed by a circle having a radius calculated based on a maximum distance between a vertex of a boundary of the partition and the K candidate objects; and
store object range information for use in K-NN queries of the spatial dataset, the object range information at least comprising the object range determined for each partition.
